(19) United States
(12) Patent Application Publication
(10) Pub. No.: US 2026/0340499 A1
(43) Pub. Date: Oct. 29, 2026

(54) ENHANCING USER-AI INTERACTION THROUGH ADAPTIVE PROMPT GENERATION FRAMEWORK

(71) Applicant: UNM RAINFOREST INNOVATIONS, Albuquerque, NM (US)

(72) Inventor: William K. SZAROLETTA, Albuquerque, NM (US)

(21) Appl. No.: 19/391,663

(22) Filed: Nov. 17, 2025

Related U.S. Application Data
(60) Provisional application No. 63/720,927, filed on Nov. 15, 2024.

(51) Int. Cl. G06N 20/00; G06F 40/289; G06F 40/35

(52) U.S. Cl. CPC G06N 20/00; G06F 40/289; G06F 40/35

(57) ABSTRACT

The disclosed invention presents a breakthrough in user-AI interaction, offering a framework that adapts to user preferences and context dynamically. By integrating machine learning-based adaptive control, this invention provides a more personalized, engaging, and efficient interaction model, positioning it as a significant improvement over existing AI prompt generation systems.

### RELATED APPLICATIONS

This application claims priority under 35 U.S.C. § 119(e) to U.S. Provisional Patent Application No. 63/720,927, filed Nov. 15, 2024, which is incorporated herein by reference.

### FIELD OF INVENTION

The invention pertains to adaptive human-AI interaction, prompt engineering, and generative systems, particularly to the application of control-system methodologies (such as feedforward, feedback, optimal, robust, predictive, fuzzy control, etc.) to user-directed prompt construction and iterative content generation under explicit human supervision to assure ownership and authorship of the generated prompt and the prompt's output from the AI Chatbot or other means.

### BACKGROUND OF THE INVENTION

### I. Introduction

Artificial Intelligence (AI) has revolutionized many aspects of modern technology, particularly in the field of natural language processing (NLP). AI chatbots and conversational agents, which are subsets of NLP, have been integrated into various platforms to enhance user experience, automate customer service, provide educational support, and assist with creative tasks. These AI systems typically rely on prompt engineering, a technique that involves designing inputs (options) to elicit useful and relevant responses from AI models. However, traditional prompt engineering frameworks often fall short in delivering dynamic and personalized interactions.

The primary limitation of traditional AI frameworks, such as Adaptive Prompt Engine (APE) and Response Initiative and Selection Engine (RISE), is their linear, non-adaptive approach. These frameworks typically employ a fixed set of rules or scripts that do not evolve based on user interaction patterns or contextual information. As a result, they often fail to provide a personalized user experience, which is crucial in applications where user engagement and satisfaction are key metrics. There is a growing demand for AI systems that can understand user preferences, adapt to changing contexts, and provide tailored responses that resonate with individual users.

This invention introduces a novel Adaptive Prompt Generation Framework designed to enhance user-AI interaction by integrating adaptive control elements that adjust dynamically based on user behavior and feedback. This framework aims to provide a more personalized, engaging, and relevant experience compared to traditional linear and non-adaptive frameworks like APE and RISE. By incorporating both feedforward and feedback adaptive control mechanisms, the framework continuously learns from user interactions, anticipating needs, and refining its responses to optimize engagement and satisfaction.

Most existing prompt-generation tools still use heuristic or trial-and-error methods. They create static lists or random variations and lack formal systems to control stylistic drift, manage creativity, or predict the cost of later edits. In high-value fields such as legal, medical, or scientific writing, this absence of control reduces reliability, traceability, and confidence in authorship.

There is a clear need for a closed-loop prompt-generation framework that:
(i) treats every interaction as part of a continuous feedback cycle;
(ii) defines its option distributions as adjustable control states; and
(iii) keeps all meaningful decisions under direct user control so that authorship always remains with the human.

### SUMMARY OF THE INVENTION

The invention introduces an Adaptive Prompt Generation Framework that enhances user-AI interaction by employing both feedforward and feedback adaptive control elements. This enables the AI system to dynamically adjust its responses based on real-time user input, preferences, and behavior. The framework is particularly suited for applications in creative writing, customer service, education, and brainstorming.

Therefore, in one embodiment, disclosed is a method for enhancing user-AI interaction, comprising: processing user input to identify contextual preferences;
generating response options dynamically, including very relevant, moderately relevant, unexpected but relevant and randomized suggestions;
employing feedforward adaptive control to anticipate user needs based on historical data;
employing feedback adaptive control to refine responses in real-time based on user interaction.

In some embodiments, the system further comprises a machine learning algorithm that continuously refines response generation based on feedback received during interactions.

In various other embodiments disclosed is a system for adaptive prompt generation, comprising:
a user input processor for extracting user context and preferences;
an option generator for producing multiple response options, including unexpected but relevant suggestions;
an adaptive learning mechanism that integrates user feedback for continuous improvement of AI interaction quality.

In some embodiments, the system response options are filtered based on user-selected preferences such as tone, style, or subject matter.

These and other features and advantages of this invention will be more fully understood from the following detailed description of the invention taken together with the accompanying claims. It is noted that the scope of the claims is defined by the recitations therein and not by the specific discussion of features and advantages set forth in the present description.

### BRIEF DESCRIPTION OF DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1. PROMPTS flowchart.

FIG. 2. Meta-Controller System Architecture

FIG. 3. Detailed Description (Control Mechanism Taxonomy Mapped to Suggestion Categories)

FIG. 4 PROMPTS Adaptive Meta-Controller Pseudocode

FIG. 5 Meta-Controller Logic+Adaptive Update Mechanisms With Documentation

FIG. 6 Strong Types+Category Definitions+Controller Interfaces With Documentation

FIG. 7 Authorship Assurance Ledger (AAL) Implementation With Documentation

FIG. 8 Master Architecture Of PROMPTS Adaptive Prompt Generation Framework

### DETAILED DESCRIPTION OF THE INVENTION

The disclosed PROMPTS architecture is expressly designed to accommodate continuous technical evolution across control, computation, and interaction modalities. The framework's modular control design supports hybrid state-space optimization, in which linear and nonlinear submodels operate concurrently, and Lyapunov-based stability proofs can be applied to verify convergence of adaptive learning dynamics. Controller parameters may be enhanced through reinforcement-learning auto-tuning, allowing the system to self-optimize using reward signals derived from user feedback and Authorship Assurance Log (AAL) data. To maintain usability, cognitive-load modeling is incorporated to measure the user's decision bandwidth and automatically scale the number and diversity of presented options. The architecture further anticipates an Ethical Constraint Controller (ECC) layer that formalizes moral and regulatory invariants as sliding-mode constraints, guaranteeing that no adaptive path violates ethical boundaries. At the computational level, PROMPTS is deployable through distributed GPU and edge-processing nodes for real-time multi-agent orchestration. All interaction states are recorded in standardized metadata formats enabling provenance interoperability across platforms, while its multi-modal interface schema supports seamless extension to image, audio, and haptic feedback channels, preserving the same closed-loop authorship control throughout.

### Specific Application within the PROMPTS Framework

Within PROMPTS, these capabilities manifest as deeper layers of adaptability and verifiability. Hybrid state-space modeling enables the system to represent the user-AI interaction as a composite of fast linguistic dynamics and slower behavioral adaptation, while Lyapunov functions provide a provable measure that each iteration reduces stylistic error energy. Reinforcement-learning auto-tuning operates as a meta-controller that continually calibrates the forty-four underlying mechanisms to the unique reward structure of each user, effectively customizing the “personality” of the assistant. Cognitive-load analytics monitor how rapidly the user can evaluate suggestions; when overload is detected, the adaptive-distribution engine automatically narrows the option set or simplifies wording. The Ethical Constraint Controller functions as a non-negotiable guardrail, ensuring transparency, truthfulness, and brand-safe expression. Distributed GPU/Edge deployment allows multi-agent PROMPTS instances to collaborate on large documents with sub-second latency. Provenance interoperability ensures that every creative contribution remains cryptographically traceable to its human author across ecosystems. Finally, multimodal integration extends the PROMPTS principles beyond text: image, sound, and haptic modalities obey identical feedback-control laws, maintaining human-in-command authorship across all generative dimensions.

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five substituents on the ring.

As will be understood by the skilled artisan, all numbers, including those expressing quantities, properties, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., percentages proximate to the recited range that are equivalent in terms of the functionality of the individual embodiment. The terms “about” and “approximately” can also modify the endpoints of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units is also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

This disclosure provides ranges, limits, and deviations to variables such as volume, mass, percentages, ratios, etc. It is understood by an ordinary person skilled in the art that a range, such as “number 1” to “number 2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number 10”, it implies a continuous range that includes whole numbers and fractional numbers less than number 10, as discussed above. Similarly, if the variable disclosed is a number greater than “number 10”, it implies a continuous range that includes whole numbers and fractional numbers greater than number 10. These ranges can be modified by the term “about”, whose meaning has been described above.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

Wherever the term “comprising” is used herein, options are contemplated wherein the terms “consisting of” or “consisting essentially of” are used instead. As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein may be suitably practiced in the absence of any element or elements, limitation, or limitations not specifically disclosed herein.

### II. Framework Overview

### A. Core Concepts and Objectives

The core objective of the Adaptive Prompt Generation Framework is to enhance user engagement by dynamically adjusting options and responses based on user behavior, preferences, and past interactions. Unlike traditional frameworks that operate on static rules and predefined logic, this adaptive framework evolves based on real-time inputs, offering a more flexible and user-centric interaction model.
1. Personalization: Tailoring responses to individual user preferences and past behavior to create a more meaningful interaction.
2. Context Awareness: Understanding the context of user inputs to generate relevant and appropriate responses.
3. Dynamism: Continuously adapting to changes in user behavior and preferences over time.
4. Engagement: Enhancing user engagement by providing a variety of response options, including unexpected yet relevant suggestions.

### B. Key Components of the Framework

The Adaptive Prompt Generation Framework is built upon several key components that work together to create a dynamic and responsive interaction model:
1. User Input Processing: This component analyzes user inputs to extract meaningful context and preferences, forming the basis for generating tailored responses.
2. Option Generation: This component creates a diverse range of response options, including closely related choices, moderately related choices, AI-generated random selections, unexpected but relevant alternatives.
3. User Interaction Interface: This component provides users with multiple-choice selections, custom input capabilities, and options to request additional suggestions, repeating the current step, or starting over, ensuring a flexible and user-friendly interaction.
4. Adaptive Learning Mechanism: This component continuously refines the option generation process based on user selections and feedback, allowing the system to evolve and adapt to changing user preferences. Although the AI

### C. Integration of Feedforward and Feedback Adaptive Control Elements

The framework incorporates both feedforward and feedback adaptive control elements to ensure a responsive and dynamic interaction loop:
1. Feedforward Adaptive Control: Anticipates user preferences based on historical data and generates proactive options that align with anticipated needs.
2. Feedback Adaptive Control: Adjusts responses in real-time based on user input, refining the framework's behavior and output to better match user preferences.

### III. Framework Components

### A. User Input Processing

The user input processing component plays a crucial role in understanding and interpreting user interactions. It is responsible for analyzing user inputs to extract meaningful context and preferences, which serve as the foundation for generating tailored responses.
1. Analysis of Previous Inputs: The framework examines past user interactions to identify patterns and preferences. This analysis helps anticipate future needs and tailor responses to align with user expectations.
   Pattern Recognition: By recognizing patterns in user behavior, such as frequently used phrases or topics of interest, the framework can generate more relevant options.
   Preference Identification: Identifying user preferences, such as preferred tone or style, allows the framework to customize responses to match individual tastes.
2. Contextual Understanding: Understanding the context in which user inputs are made is essential for generating appropriate responses. The framework uses context-aware algorithms to interpret user inputs and determine the most relevant response options.
   Context Analysis: The framework analyzes the context of user inputs, such as the current conversation topic, user intent, and emotional tone, to generate contextually appropriate responses.
   Dynamic Context Adaptation: The framework adapts to changes in context over the course of a conversation, ensuring that responses remain relevant and engaging.

### B. Option Generation

The option generation component is responsible for creating a diverse range of response options, ensuring that the user has a variety of choices to select from.
1. Closely Related Options: These options are generated based on the immediate context and user preferences to ensure relevance and continuity in the conversation.
   Contextually Relevant Options: By generating options that closely relate to the current topic or user input, the framework maintains the flow of conversation and enhances user engagement.
   Preference-Aligned Responses: Options are tailored to align with user preferences, providing a personalized interaction experience.
2. AI-Generated Random Selections: Introducing randomness to the options can provide creativity and prevent monotonous interactions.
   Creative Divergence: Random selections introduce creative divergence, encouraging users to explore new ideas and perspectives.
   Preventing Repetition: By generating random options, the framework avoids repetition and keeps the interaction dynamic and interesting.
3. Unexpected but Relevant Options: These options are generated to surprise and engage users, keeping the interaction lively and stimulating.
   Surprise and Delight: Unexpected options can surprise users, creating a sense of novelty and excitement in the interaction.
   Relevant Innovation: While unexpected, these options remain relevant to the context, ensuring that they contribute meaningfully to the conversation.

### C. User Interaction Interface

The user interaction interface is designed to be intuitive and user-friendly, providing users with multiple-choice selections, custom input capabilities, options to request additional suggestions, options.
1. Multiple-Choice Selection: Users can select from a range of AI-generated options, ensuring they have control over the interaction direction.
   User Empowerment: Providing multiple-choice selections empowers users to guide the conversation according to their preferences.
   Choice Variety: A variety of choices ensures that users can select the option that best aligns with their interests and needs.
2. Custom Input Capability: Users are encouraged to input their responses, fostering a sense of agency and personalization.
   Personalized Interaction: Allowing users to input their responses enables a more personalized and engaging interaction.
   Flexibility: Custom input capability provides flexibility, accommodating a wide range of user needs and preferences.
3. Request for Additional Options: Users can request more options, promoting an iterative exploration of ideas and responses.
   Iterative Exploration: By requesting additional options, users can explore different ideas and perspectives, enriching the interaction.
   Enhanced Engagement: Providing the ability to request more options keeps users engaged and invested in the conversation.
4. Request for Repeat Current Step: Users may repeat the current PROMPTS step if they are not satisfied with the presented options or need a fresh starting point.
   Quality Assurance: Repeating a step empowers users to refine inputs until they reach outputs that meet their expectations.
   Adaptive Control: Each redo provides the system with new feedback signals, allowing the adaptive framework to recalibrate suggestion entropy, tone stability, and semantic precision.
   Nonlinear Progress: Redoing a step prevents users from feeling locked into choices and supports a flexible, user-centered workflow.
5. Request for Restart Process From Beginning: Users may reset the entire PROMPTS process and begin again from Step 1.
   Full Reinitialization: Restarting resets all temporary variables, user-selected states, and adaptive category parameters.
   Clean Slate: This option ensures users can abandon unproductive pathways and restart without residual bias from previous actions.
   User Control: Restarting underscores the core design principle that users maintain complete authorship and directional authority.
6. Request AI to Propose a Pseudo-Random Option: Users can instruct the system to propose one or more pseudo-randomly selected options from the current option set. The AI may also generate additional adjacent or creative variations based on internal weighting and prior user behavior. In all cases, the user retains full control over whether to accept, modify, or reject the proposed option.
   User Cognitive Relief with Retained Control: This feature can reduce decision fatigue by allowing the system to suggest a starting point, while the user remains free to override the suggestion at any time. The AI does not make binding decisions. It only proposes candidates for the user to review.
   AdaptivevRandomness: The meta-controller uses internal signals, such as prior selections, re-roll frequency, and observed openness to novelty, to weight the pseudo-random choice. The selection process is guided rather than purely random, but the final authority always rests with the user.
   Explicit User Confirmation: After a pseudo-random option is proposed, the system prompts the user to either accept, refine, request a new suggestion, or return to multiple-choice or custom input modes. No option enters the next PROMPTS step or the final prompt produced by PROMPTS without explicit user confirmation.

### D. Adaptive Learning Mechanism

The adaptive learning mechanism is a critical component of the framework, enabling continuous refinement of option generation based on user selections and feedback.
1. Processing and Integration of User Choices: The framework learns from user selections, refining future prompt generations to better match user preferences.
   Learning from Feedback: By processing user feedback and choices, the framework continuously improves its understanding of user preferences.
   Adaptive Refinement: The framework adapts its behavior based on user feedback, ensuring that future interactions are more aligned with user expectations.
2. Continuous Refinement of Option Generation: The system continuously updates its understanding of user preferences and context, ensuring an evolving and adaptive interaction model.
   Dynamic Learning: The framework employs dynamic learning algorithms to continuously update its knowledge base and improve option generation.
   Adaptive Evolution: The system evolves over time, adapting to changes in user preferences and behavior to provide a more personalized experience.

### IV. Adaptive Control Elements

### A. Feedforward Adaptive Control

Feedforward adaptive control is a proactive approach that anticipates user preferences and generates options accordingly.
1. Anticipating User Preferences Based on Previous Inputs: By leveraging historical interaction data, the framework proactively generates options that align with anticipated user needs.
   Data-Driven Anticipation: The framework uses data-driven techniques to predict user preferences based on past behavior and interactions.
   Proactive Personalization: Anticipating user needs allows the framework to provide a more personalized experience, enhancing user satisfaction.
2. Proactive Option Generation: The system generates options that not only respond to current inputs but also anticipate future user needs and contexts.
   Forward-Looking Options: By generating forward-looking options, the framework stays ahead of user needs and maintains engagement.
   Context-Aware Anticipation: The system anticipates changes in context and adjusts its responses accordingly, ensuring a seamless interaction experience.

### B. Feedback Adaptive Control

Feedback adaptive control is a reactive approach that adjusts responses based on user input, refining the framework's behavior in real-time.
1. Incorporating User Selections and Custom Inputs: Real-time analysis of user choices allows the system to adjust its behavior and output dynamically.
   Real-Time Adaptation: The framework adjusts its responses in real-time based on user feedback, ensuring a responsive and adaptive interaction.
   User-Driven Refinement: User selections and custom inputs are incorporated into the framework's learning process, refining future interactions.
2. Real-Time Adjustment of the Framework's Behavior: The framework continuously refines its responses based on user feedback, ensuring a more responsive and engaging interaction.
   Dynamic Response Adjustment: The framework dynamically adjusts its responses based on real-time feedback, enhancing user engagement.
   Continuous Improvement: By continuously refining its behavior, the framework ensures that interactions remain relevant and personalized over time.

### V. Implementation and Architecture

### A. System Design

The Adaptive Prompt Generation Framework is designed with modularity and scalability in mind, allowing for flexible integration with various AI systems and platforms. The architecture supports real-time processing and adaptation, ensuring seamless user experiences.
1. Modular Architecture: The framework is built using a modular architecture, allowing for easy integration with different AI systems and platforms.
   Scalability: The modular design enables the framework to scale easily, accommodating a growing user base and expanding functionality.
   Flexibility: The modular architecture provides flexibility, allowing developers to customize and extend the framework to meet specific needs.
2. Real-Time Processing: The framework is designed to process user inputs and generate responses in real-time, ensuring a smooth and responsive interaction experience.
   Low Latency: Real-time processing ensures low latency, providing users with immediate feedback and enhancing engagement.
   Seamless Integration: The framework seamlessly integrates with existing AI systems, providing a consistent and unified user experience.

### B. Algorithms for Option Generation and Selection

Advanced algorithms are employed to analyze user inputs, generate diverse response options, and adapt to user feedback. These algorithms leverage machine learning techniques to continuously improve the system's performance.
1. Machine Learning Algorithms: The framework utilizes machine learning algorithms to analyze user inputs and generate response options.
   Natural Language Processing (NLP): NLP techniques are used to understand user inputs, extract meaningful context, and generate relevant responses.
   Reinforcement Learning: Reinforcement learning algorithms are employed to adapt the framework's behavior based on user feedback, ensuring continuous improvement.
2. Option Selection Algorithms: The framework uses sophisticated algorithms to select the most appropriate response options based on user preferences and context.
   Context-Aware Selection: The option selection algorithms take into account the context of user inputs, ensuring that responses are relevant and appropriate.
   Preference-Based Filtering: The algorithms filter response options based on user preferences, providing a personalized interaction experience.

### C. User Interface Considerations

The user interface is designed to be intuitive and user-friendly, providing easy access to multiple-choice selections, custom input capabilities, and additional options. This design ensures that users can interact with the AI system in a manner that best suits their preferences.
1. Intuitive Design: The user interface is designed to be intuitive and easy to use, ensuring a smooth and enjoyable user experience.
   User-Friendly Navigation: The interface provides clear and straightforward navigation, allowing users to easily select options and input responses.
   Accessibility: The design takes into account accessibility considerations, ensuring that the interface is usable by a wide range of users.
2. Customizability: The user interface is customizable, allowing users to tailor the interaction experience to their preferences.
   Personalized Settings: Users can customize the interface settings, such as font size and color scheme, to suit their preferences.
   Dynamic Interface Elements: The interface dynamically adjusts to user behavior, providing a responsive and personalized experience.

### VI. Sampling of Use Cases and Applications

The Adaptive Prompt Generation Framework has a wide range of applications, providing personalized and engaging experiences across various domains.

### A. Creative Writing Assistance

The adaptive framework can be used to assist writers by generating creative options and suggestions, helping overcome writer's block and sparking new ideas.
1. Prompt Generation: The framework generates creative options based on user input, providing writers with inspiration and new ideas.
   Contextual Options: The framework generates options that are relevant to the writer's current work, ensuring a seamless integration with their creative process.
   Diverse Suggestions: The framework provides a diverse range of options encouraging writers to explore different ideas and perspectives.
2. Idea Exploration: The framework encourages writers to explore different ideas and perspectives, fostering creativity and innovation.
   Creative Divergence: By providing a variety of option variations, the framework encourages writers to think outside the box and explore new ideas.
   Iterative Refinement: Writers can refine their ideas through iterative exploration, using the framework to generate new options and suggestions based on their feedback.

### B. Problem-Solving and Brainstorming

In brainstorming sessions, the framework can provide diverse options and perspectives, encouraging innovative thinking and collaborative problem-solving.
1. Diverse Option Generation: The framework generates a wide range of options and perspectives, encouraging users to explore different solutions and ideas.
   Multi-Perspective Options: The framework provides options from multiple perspectives, encouraging users to consider different viewpoints and solutions.
   Innovative Thinking: By providing diverse options, the framework fosters innovative thinking and encourages users to explore new ideas.
2. Collaborative Brainstorming: The framework supports collaborative brainstorming sessions, allowing multiple users to contribute ideas and suggestions.
   Shared Interface: The framework provides a shared interface for brainstorming sessions, enabling users to collaborate and contribute ideas in real-time.
   Dynamic Interaction: The framework dynamically adjusts its options based on user input, ensuring that the brainstorming session remains engaging and productive.

### C. Educational Tools and Personalized Learning

The adaptive framework can personalize learning experiences by generating options and questions tailored to individual students' learning styles and progress.
1. Personalized Learning: The framework generates personalized options and questions based on individual students' learning styles and progress.
   Adaptive Questioning: The framework adapts its questioning based on student responses, ensuring that questions are tailored to the student's level of understanding.
   Learning Style Adaptation: The framework takes into account individual learning styles, generating options and questions that match the student's preferred learning method.
2. Engaging Educational Tools: The framework provides engaging educational tools that encourage active learning and participation.
   Interactive Learning: The framework provides interactive learning tools, such as quizzes and games, that encourage students to actively engage with the material.
   Feedback-Driven Learning: The framework uses feedback from student responses to continuously refine its options and questions, ensuring that the learning experience remains engaging and effective.

### VII. Evaluation and Performance Metrics

To evaluate the effectiveness of the Adaptive Prompt Generation Framework, several performance metrics are used, including user satisfaction, engagement levels, and adaptability.

### A. User Satisfaction and Engagement

User satisfaction and engagement are key metrics for evaluating the framework's effectiveness in providing meaningful interactions.
1. User Satisfaction Scores: User satisfaction scores are collected through surveys and feedback forms to assess the framework's ability to meet user needs and preferences.
   Survey Analysis: Surveys are used to collect feedback from users, allowing developers to assess the framework's performance and identify areas for improvement.
   Feedback Integration: User feedback is integrated into the framework's learning process, ensuring continuous improvement and adaptation.
2. Engagement Levels: Engagement levels are measured through user interaction data, such as the number of options selected and the frequency of custom inputs.
   Interaction Data Analysis: User interaction data is analyzed to measure engagement levels and identify patterns in user behavior.
   Engagement Optimization: The framework uses engagement data to optimize its options and responses, ensuring a more engaging interaction experience.

### B. Quality and Relevance of Generated Options

The quality and relevance of the options generated by the framework are assessed based on user feedback and objective criteria.
1. User Feedback: User feedback is collected to assess the quality and relevance of the generated options, providing valuable insights into the framework's performance.
   Feedback Collection: User feedback is collected through surveys, feedback forms, and interaction data, allowing developers to assess the quality of the generated options.
   Continuous Improvement: Feedback is used to continuously improve the framework's option generation process, ensuring that responses remain relevant and high-quality.
2. Objective Criteria: Objective criteria, such as relevance to the context and alignment with user preferences, are used to evaluate the quality of the generated options.
   Contextual Relevance: The relevance of the generated options to the context of the conversation is assessed using objective criteria, ensuring that responses are appropriate and meaningful.
   Preference Alignment: The alignment of the generated options with user preferences is evaluated based on objective criteria, ensuring a personalized interaction experience.

### C. Adaptability and Learning Curve of the System

The system's ability to adapt to new users and contexts is measured, ensuring it can provide personalized experiences for a wide range of users.
1. Adaptability Metrics: Metrics such as the system's response time to new user inputs and the accuracy of its predictions are used to assess its adaptability.
   Response Time: The system's response time to new user inputs is measured to evaluate its adaptability and responsiveness.
   Prediction Accuracy: The accuracy of the system's predictions, such as its ability to anticipate user preferences, is assessed to evaluate its adaptability.
2. Learning Curve: The learning curve of the system is measured to assess how quickly it can adapt to new users and contexts.
   User Adaptation Time: The time it takes for the system to adapt to new users and contexts is measured, providing insights into its learning curve.
   Adaptation Efficiency: The system's efficiency in adapting to new users and contexts is evaluated based on its learning curve, ensuring a personalized and engaging interaction experience.

### VIII. Challenges and Future Work

The Adaptive Prompt Generation Framework faces several challenges that must be addressed to ensure its continued success and development.

### A. Balancing Diversity and Relevance in Option Generation

The learning curve of the system is measured to assess how quickly it can adapt to new users and contexts.
User Adaptation Time: The time it takes for the system to adapt to new users and contexts is measured, providing insights into its learning curve.
Adaptation Efficiency: The system's efficiency in adapting to new users and contexts is evaluated based on its learning curve, ensuring a personalized and engaging interaction experience.

### VIII. Challenges and Future Work

The Adaptive Prompt Generation Framework faces several challenges that must be addressed to ensure its continued success and development.

### A. Balancing Diversity and Relevance in Option Generation

One of the key challenges of the framework is balancing the diversity of generated options with their relevance to the context and user preferences.
1. Diversity vs. Relevance: The framework must strike a balance between generating diverse options that encourage creativity and exploration, and maintaining relevance to the user's needs and preferences.
   Relevance Filtering: The framework uses relevance filtering algorithms to ensure that the generated options remain relevant to the user's needs and preferences.
   Diversity Encouragement: The framework encourages diversity by generating options from a variety of perspectives, ensuring that users are exposed to different ideas and viewpoints.
2. Balancing Algorithms: The framework employs balancing algorithms to ensure that the generated options are both diverse and relevant, maintaining a high-quality interaction experience.
   Diversity-Relevance Balance: The balancing algorithms take into account both diversity and relevance, ensuring that the generated options provide a meaningful and engaging interaction experience.
   Contextual Adaptation: The framework adapts its balancing algorithms based on the context of the conversation, ensuring that responses remain appropriate and relevant.

### B. Handling Complex, Multi-Step Interactions

The framework must be capable of managing complex interactions that involve multiple steps and decision points.
1. Multi-Step Interaction Management: The framework uses advanced algorithms to manage complex, multi-step interactions, ensuring that users can navigate through decision points smoothly.
   Step-by-Step Guidance: The framework provides step-by-step guidance for complex interactions, ensuring that users can navigate through decision points without confusion.
   Complex Interaction Handling: The framework employs complex interaction handling algorithms to manage multi-step interactions, ensuring that the conversation remains fluid and engaging.
2. Decision Point Optimization: The framework optimizes decision points by providing relevant and appropriate options for each step of the interaction.
   Contextual Decision Points: The framework uses contextual analysis to optimize decision points, ensuring that each step of the interaction is relevant and meaningful.
   Adaptive Guidance: The framework provides adaptive guidance throughout the interaction, ensuring that users can make informed decisions at each step.

### C. Potential Improvements and Extensions of the Framework

Future work will focus on enhancing the framework's capabilities, including improving its adaptability and expanding its applications to new domains.
1. Improving Adaptability: Future developments will focus on improving the framework's adaptability, ensuring that it can provide personalized experiences for a wider range of users and contexts.
   Advanced Learning Algorithms: The framework will employ advanced learning algorithms to improve its adaptability, ensuring that it can quickly adapt to new users and contexts.
   Cross-Domain Adaptation: The framework will be extended to adapt to new domains, ensuring that it can provide personalized experiences across a wide range of applications.
2. Expanding Applications: The framework will be expanded to new applications, such as healthcare, customer service, and entertainment, providing personalized and engaging experiences in different domains.
   Healthcare Applications: The framework will be extended to healthcare applications, providing personalized options and responses for medical professionals and patients.
   Customer Service Applications: The framework will be extended to customer service applications, providing personalized and engaging interactions for customer service agents and customers.

### IX. Ethical Considerations

The Adaptive Prompt Generation Framework must address several ethical considerations to ensure its responsible development and use.

### A. User Privacy and Data Handling

The framework must ensure user privacy by securely handling and storing data in compliance with relevant regulations.
1. Data Privacy Regulations: The framework must comply with data privacy regulations, such as the General Data Protection Regulation (GDPR), to ensure that user data is handled securely.
   Data Encryption: The framework employs data encryption techniques to protect user data and ensure privacy.
   Compliance Audits: The framework undergoes regular compliance audits to ensure that it adheres to data privacy regulations and best practices.
2. User Data Security: The framework employs advanced security measures to protect user data from unauthorized access and breaches.
   Secure Data Storage: User data is stored securely in encrypted databases, ensuring that it is protected from unauthorized access.
   Access Control: The framework uses access control measures to ensure that only authorized personnel have access to user data.

### B. Transparency in AI Decision-Making

Transparency in how the AI system generates options and makes decisions is crucial for building trust with users.
1. AI Transparency: The framework must provide transparency in its decision-making processes, ensuring that users understand how options are generated and selected.
   Decision Explanation: The framework provides explanations for its decisions, allowing users to understand how options are generated and why certain choices are recommended.
   Transparent Algorithms: The framework uses transparent algorithms to generate and select options, ensuring that users can trust the system's decision-making processes.
2. User Control: The framework provides users with control over the interaction, allowing them to select and customize responses according to their preferences.
   User-Driven Decisions: The framework empowers users to make decisions based on their preferences, ensuring that they remain in control of the interaction.
   Customizable Settings: Users can customize the framework's settings, such as tone and style, to suit their preferences, providing a personalized and transparent interaction experience.

### C. Avoiding Biases in Option Generation

Efforts must be made to minimize biases in option generation, ensuring fairness and inclusivity in user interactions.
1. Bias Detection and Mitigation: The framework employs bias detection and mitigation techniques to ensure that options are generated fairly and inclusively.
   Bias Detection Algorithms: The framework uses bias detection algorithms to identify and mitigate biases in option generation, ensuring fairness and inclusivity.
   Diverse Training Data: The framework is trained on diverse datasets to ensure that it generates options that are inclusive and representative of different perspectives.
2. Fairness in Option Generation: The framework ensures that options are generated fairly, providing users with diverse and inclusive choices.
   Inclusive Option Generation: The framework generates options that are inclusive and representative of different perspectives, ensuring fairness in the interaction.
   Bias-Free Responses: The framework ensures that responses are free from biases, providing users with fair and unbiased options.

### X. Conclusion

The Adaptive Prompt Generation Framework represents a significant advancement in user-AI interaction, providing dynamic, personalized, and engaging experiences. By moving beyond traditional linear and non-adaptive frameworks like APE and RISE, this novel framework offers a more flexible and user-centric interaction model that adapts to user preferences and contexts in real-time.

The integration of feedforward and feedback adaptive control mechanisms allows the framework to continuously learn from user interactions, providing a more personalized and responsive experience. This adaptability has the potential to revolutionize how users interact with AI systems across various domains, from creative writing and brainstorming to personalized learning and customer service.

As the framework continues to evolve, future developments will focus on improving its adaptability, expanding its applications, and addressing challenges such as balancing diversity and relevance in option generation and handling complex, multi-step interactions. By addressing these challenges and incorporating ethical considerations such as user privacy, transparency, and fairness, the Adaptive Prompt Generation Framework has the potential to shape the future of user-AI interactions, paving the way for more adaptive and intelligent AI systems.

### EXAMPLES

The present invention is further illustrated and supported by the following examples. However, these examples should in no way be considered to further limit the scope of the invention. To the contrary, one having ordinary skill in the art would readily understand that there are other embodiments, modifications, and equivalents of the present invention without departing from the spirit of the present invention and/or the scope of the appended claims.

### PROMPTS Process: Detailed Step-by-Step User Guide

### Key Elements of PROMPTS

Allow the user to specify a custom parameter for GPT's length of options (between 6 and 20)
Dynamically update dependent steps based on the user's input.
Summarize the inputs at the end of each step
Provide options to input the user's custom input, to select from the options provided by the system, to redo the step, to start over, to let the system randomly select on or more, or proceed to the next step.

The following early PROMPTS example below uses only one suggestion category (Narrowly Aligned). The preferred embodiment of PROMPTS includes four categories including Narrowly Aligned, Moderately Aligned, Creatively Divergent, and Dynamically Adjusted with each adaptively balanced by the Meta-Controller.

### Step 1: Project Name, Project Leader, Project Focus

In the first step, the user sets the foundation for their project by defining its essential elements. Begin by naming the project in 3 to 5 concise words that capture its essence. This step ensures that your project has a clear identity. Next, assign a project leader or group who will take responsibility for guiding the project to completion. This individual or team will oversee decisions and ensure the vision aligns with goals. Finally, you will define the primary focus area of the project. This focus can be informed by attaching relevant documents or describing your vision. The AI will provide you with a list of related focus areas to refine your ideas further. Select one or propose your own, and this will set the direction for the subsequent steps.

### Step 2: Roles, Responsibilities, and Resources

Step 2 involves detailing the roles, responsibilities, and resources essential to the project's success. The AI will generate a list of potential roles it can assume to support the project—these could range from a research assistant to a strategic advisor. Select the most appropriate role or suggest your own. Similarly, the AI will propose a list of resources that could aid your project, such as datasets, templates, or toolkits. You can choose from the suggestions or customize your resources to fit the project's needs. This step ensures clarity in what the AI will do and what resources are available to support it.

### Step 3: Outcomes and Options

With the foundational elements in place, Step 3 focuses on defining the desired outcomes and exploring actionable options. The AI conducts background analysis to provide insights on trends, challenges, and opportunities within the project's focus area. It then generates a list of potential outcomes—specific goals, audience impacts, timelines, and broader impacts—for you to evaluate. After selecting an outcome, the AI proposes a set of actionable options, offering diverse approaches to achieving your chosen goals. This step enables you to create a roadmap with clear objectives and strategies.

### Step 4: Motivation and Messaging

Step 4 delves into the “why” and “how” of your project. The AI generates potential motivations, helping you articulate the driving forces behind the initiative. These motivations could range from solving a pressing problem to achieving a strategic advantage. Once you've chosen the motivations, the AI assists in crafting core messages that resonate with stakeholders. These messages communicate the project's purpose and value effectively. By combining motivation with messaging, this step helps to solidify your project's narrative and strategic intent.

### Step 5: Prepare Plan and Prioritize

Step 5 transitions from planning to actionable steps. The AI suggests detailed preparation plans tailored to your focus area and goals. These plans outline necessary steps, resources, and timelines to initiate your project. Once the preparation is clear, the AI helps prioritize the tasks, ensuring you focus on high-impact activities. This step includes quick wins and longer-term initiatives, enabling a balanced approach to project execution. By organizing and prioritizing actions, you can efficiently move your project forward.

### Step 6: Tone and Transformation

In Step 6, the AI focuses on refining the style and transformation aspects of your project. First, it offers a range of tones—from formal and professional to conversational or empathetic—to align with your intended audience. Once you've chosen a tone, the AI explores transformational paths to highlight how the project can evolve or create significant impact. These paths may involve innovative strategies, stakeholder engagement, or paradigm shifts. This step ensures that your project communicates effectively and embodies its transformative potential.

### Step 7: Style, Specify Output, Synthesize Prompt

The final step synthesizes all inputs into a cohesive and actionable prompt. The AI suggests potential styles, such as detailed technical documentation or engaging storytelling, to match your project's needs. You can also emulate specific writing styles or formats to ensure consistency and quality. Finally, the AI generates a range of output options—reports, presentations, summaries, or other formats—based on your selections. This comprehensive step brings together all prior inputs to deliver a polished, world-class prompt that guides your project to success.

### Example of PROMPTS the Adaptive Prompt Generation Framework

### “Step 1 of PROMPTS: Project Name, Project Leader, Project Focus”

1. To the user: “Welcome to Step 1 of PROMPTS™!Let's get started: Please name this project in 3 to 5 words”
2. Stop your output and wait for the user input for project name and name this input as [Project Name].
3. To the user: “Please name of the project leader or group who will be responsible for: leading the project, making key decisions, and ensuring the vision is realized”
4. Stop your output and wait for the user input for project leader and name this input as [Project Leader].
5. To the user: “Thank you for entering the name of your project: [Project Name] and the project leader: [Project Leader]. Let's proceed to Step 1 of PROMPTS to develop your world-class prompt.”
6. Please propose the Focus Area that you wish to explore for [Project Name]. If you have documents that describe your area of interest for [Project Name], please attach them to the Chat Interface using the paperclip icon.”
7. Stop your output and wait for the user input and assign this input as [Focus Area]. Generate a numbered list of 12 unique and interesting [Focus Area] very closely related to the specified [Focus Area] using the methods described in this disclosure and including the keywords or variations on the keywords in [Focus Area] and include a short explanation listed in comma-separated form with item number 1 being their initially input [Focus Area] and the other 12 with explanations being numbered 2 through 13 in list form.
8. To the user: “To help you dial in your Focus Area, here is your original focus are followed by 12 new focus areas some of which are very closely related to your initial input while others are potentially less aligned. My hope is that these might give you some new ideas. Please select from this new list by entering its number (1-13) or enter a Custom Focus Area by typing in ‘custom’ which will enable you to enter your input or by typing in ‘random’ which will enable the AI Chatbot to pseudo-randomly compute one of the 13 options.”
9. Stop your output and wait for the user input that you will designate as [Chosen Focus Area]. After the user selects their [Chosen Focus Area], generate a list of 12 varied [Actions] in comma-separate form with that add significant meaning to the [Chosen Focus Area]. These phrases should encourage different types of engagement with the topic, providing the user with a broad range of options. Concatenate these 12 [Actions] with the [Chosen Focus Area] so this new list makes grammatical sense. Display the combined [Chosen Focus Area] and [Actions] list to user . . . calling it [Action Focus Area] followed by a concise one sentence explanation that you generate for each item.
10. To the user: “Earlier you chose: [Chosen Focus Area]. I've thought about your input and want to give you some more refined choices. Please choose one from this list of 12 or type ‘custom’ to input your own input or type ‘random’ to have the AI Chatbot pseudo-randomly choose one of the 12 choices.”
11. Stop your output and wait for the user input and label it [Chosen Action Focus Area]
12. To the user: “You have selected: [Chosen Action Focus Area] to focus on. In doing so you are almost finished with Step 1 of PROMPTS™. Here is a summary of your inputs so far:
   Project Name: [Project Name]
   Project Lead: [Project Leader]
   Project Focus Area: [Chosen Action Focus Area] with explanation
      Please input the number indicating your choice of how to proceed:
1. Redo Step 1 of PROMPTS with 12 new choices that you can evaluate and choose from?
2. Proceed to Step 2 of PROMPTS using [Chosen Action Focus Area]?”
3. Stop your output and wait for the user input”

### “Step 2: Roles, Responsibilities, and Resources”

1. Generate a numbered list of 12 [Roles] that the AI Chatbot can act as that directly apply to the [Chosen Action Focus Area] with 3 to 5 word elaboration to give additional richness and depth to guide both the user and you in specifying the proper role that you as the AI Chatbot should assume. For instance, if the [Chosen Action Focus Area] is to write a best-selling, non-fiction book, roles that you generate might include: World-Class Author: The primary writer who creates the content of the book, Co-Author or Collaborator: In some cases, there may be multiple authors working together on the book, Research Assistant: Helps gather information, data, and sources for the author. Editor: Reviews and refines the manuscript for clarity, structure, and style. Fact-checker: Verifies the accuracy of information presented in the book. Proofreader: Checks for grammatical, spelling, and formatting errors. Beta Readers: Individuals who read early drafts and provide feedback. Subject Matter Expert: Consulted for specialized knowledge in the book's topic area. Literary Agent: Represents the author and helps sell the book to publishers. Publisher: Oversees the production and distribution of the book. Indexer: Creates the index for easy reference of topics within the book. Book Designer: Designs the layout and cover of the book.
2. To the user: “Here are 12 specific Roles that I . . . as your AI Chatbot . . . can act as that can apply to your chosen: [Chosen Action Focus Area]. Please select one by entering the corresponding number or type ‘custom’ to input your own input or type ‘random’ to have the AI Chatbot pseudo-randomly choose one of the 12 choices.”
3. Stop your output and wait for the user input and set this input as [Chosen Role]. Next, generate and output a numbered list of 10 [Resources] that you as AI Chatbot think can directly apply to within the [Chosen Action Focus Area] and [Chosen Role] with 3 to 5 word elaboration to give additional richness and depth to guide both the user and you in specifying the proper resources that the AI Chatbot can generate.
4. To the user: “Here are 12 specific [Resources] that I . . . as your AI Chatbot . . . have generated that directly apply to your chosen [Chosen Action Focus Area] and [Chosen Role]. Please select one or more by entering the corresponding number or numbers, type ‘custom’ to input your own input or type ‘random’ to have the AI Chatbot pseudo-randomly choose one or more of the 12 choices.”
5. Stop your output and wait for the user input to select [Chosen Resources]
6. To the user: “In Step 2 of PROMPTS™, you have specified the Role of the AI Chatbot, the Responsibilities including project team name and project lead, and the Resources required. Here is a summary of your inputs for Step 2:
Role: [Chosen Role] with explanation
Resources: [Chosen Resources]
I have now completed Step 2 of PROMPTS and further developed your final prompt. Please enter the number of how you would like to proceed (Note that the numbering is meant to correspond to the step number so the Step 2 list starts with 2):
   1. Redo Step 2 of PROMPTS to revise your inputs.
   2. Proceed to Step 3 of PROMPTS to collect your input and further develop the final prompt.
   3. Stop your output and wait for the user input”

### “Step 3: Outcomes and Options”

1. To the user: “I'm going to do some thinking now about your inputs and will soon ask you questions about your desired Outcomes and Options. This might take some time, so maybe grab a coffee or tea.”
2. Stop your output to the user.
3. Perform your analysis of the following in background mode and DO NOT show it to the user:
Analyze current trends, challenges, and opportunities in the [Chosen Action Focus Area], [Chosen Role], and [Chosen Resources]
Analyze the historical context of how the [Chosen Action Focus Area], [Chosen Role], and [Chosen Resources] have evolved over time, and compare it with available benchmarks to identify gaps or areas for improvement.
Identify and analyze key competitors or alternative approaches within the [Chosen Action Focus Area]. Identify their strengths, weaknesses, and market positioning.
Explore broader market trends that are influencing the [Chosen Action Focus Area] such as technological advancements, regulatory changes, or shifts in consumer behavior.
Identify the key demographics that are most impacted or involved with the [Chosen Action Focus Area], [Chosen Role], and [Chosen Resources]. Consider factors like age, industry, geographic location, and professional roles.
If appropriate based on previous inputs, outline the primary stakeholders who have a vested interest in the outcomes related to the [Chosen Action Focus Area], [Chosen Role], and [Chosen Resources]. This could include industry leaders, corporate decision-makers, or specific departments within an organization.
Define the target audience for any initiatives, content, or strategies developed for the [Chosen Action Focus Area], [Chosen Role], and [Chosen Resources]. This could include employees, customers, potential customers, or other relevant groups.
Identify the inherent strengths of the [Chosen Action Focus Area], [Chosen Role], and [Chosen Resources], such as existing resources, brand reputation, or unique capabilities.
Outline potential weaknesses or limitations for the [Chosen Action Focus Area], [Chosen Role], and [Chosen Resources] including resource constraints, skill gaps, or areas of underperformance.
   4. Highlight external opportunities for the [Chosen Action Focus Area], [Chosen Role], and [Chosen Resources] that could be leveraged, such as emerging markets, technological innovations, or partnerships.
Discuss potential threats to the [Chosen Action Focus Area], [Chosen Role], and [Chosen Resources], including market competition, economic downturns, or regulatory challenges.
Identify potential risks associated with the [Chosen Action Focus Area], [Chosen Role], and [Chosen Resources], including financial, operational, and strategic risks. Suggest strategies for mitigating these identified risks, such as contingency planning, diversification, or risk-sharing agreements.
Analyze how the [Chosen Action Focus Area], [Chosen Role], and [Chosen Resources] aligns with the broader goals and objectives of the customer, organization or industry. Discuss synergies with other initiatives and overall strategic fit. Discuss the resources (e.g., time, budget, personnel) required to effectively pursue initiatives within the [Chosen Action Focus Area].
Outline what success looks like for the [Chosen Action Focus Area], [Chosen Role], and [Chosen Resources], including key performance indicators (KPIs) and desired outcomes. Consider potential failure points and what could go wrong, providing a contingency plan for these situations.
Define immediate next steps that can be taken to address the [Chosen Action Focus Area], [Chosen Role], and [Chosen Resources], including quick wins and high-priority tasks. Provide a roadmap for longer-term initiatives, including milestones, timelines, and key deliverables.
Brainstorm innovative ideas or out-of-the-box solutions that could be applied to the [Chosen Action Focus Area], [Chosen Role], and [Chosen Resources].
Explore critical references, tools, or documents that can support the understanding or development of strategies in the [Chosen Action Focus Area].
   5. Plan your prompt to include the information from the previous steps along with these new steps. Don't share this intermediate information with the user, but use this information as a guide on the path to developing a world-class prompt. Only show the user what I ask you to show them which is information between the ““marks.
   6. Please generate numbered list of 12 [Outcomes] that are potentially applicable to the [Chosen Action Focus Area], [Chosen Role], [Chosen Resources] and insights you have gleaned by performing the background tasks in Step 3. These [Outcomes] can include three options for the specific goal or outcome the user wants to achieve in the [Chosen Action Focus Area], three options for the desired outcome for the intended audience or beneficiary of the actions or strategies, three options for the time frame within which the actions need to be completed, and three options for the broader impact or change the user wants to accomplish.
   7. To the user: “I have worked in the background to collect a lot of information related to your [Chosen Action Focus Area], [Chosen Role], [Chosen Resources relative to generating a world-class prompt for you. Here are 12 applicable Outcomes that could apply. Please select one or more by entering the corresponding number or numbers, and/or type ‘custom’ to input your own input or type ‘random’ to have the AI Chatbot pseudo-randomly choose one of the 12 choices.”
   8. Stop your output and wait for the user input to select [Outcomes] and use that selection as [Chosen Outcomes].
   9. Please generate numbered list of 12 [Options] that are potentially applicable to the [Chosen Action Focus Area], [Chosen Role], [Chosen Resources], [Chosen Outcomes] and insights you have gleaned by performing the background tasks in Step 3.
   10. To the user: “Based on your previous inputs and my analysis, here are 12 applicable Options that could apply to your prompt. Please select one or more by entering the corresponding number, and/or type ‘custom’ to input your own input or type ‘random’ to have the AI Chatbot pseudo-randomly choose one of the 12 choices.”
   11. Stop your output and wait for the user input to select [Options]. After the user selects from the [Options] list or inputs their own [Options], use their selection or sections as [Chosen Options].
   12. To the user: “In Step 3 of PROMPTS™, you have specified the Outcomes and Options. Here is a summary of your inputs for Step 3:
Project Name: [Project Name]
Project Lead: [Project Leader]
Project Focus Area: [Chosen Action Focus Area] with explanation
Role: [Chosen Role] with explanation
Required Resources: [Chosen Resources] with explanation
Outcomes: [Chosen Outcomes] with explanation
Options: [Chosen Options] with explanation
   13. I have now completed Step 3 of PROMPTS and further developed your final prompt. Please enter the number of how you would like to proceed (Note that the numbering is meant to correspond to the step number):
1. Redo Step 3 to revise or refine the [Chosen Outcome] or [Chosen Action Focus Area] or [Chosen Role]?
2. Proceed to Step 4 of PROMPTS to collect more of your inputs?
3. Stop your output and wait for the user input”

### “Step 4: Motivation and Messaging”

1. Based on the [Chosen Action Focus Area], [Chosen Role], Chosen Resources],[Chosen Outcomes], [Chosen Options], and any relevant background information or calculations, please generate and display 10 relevant motivational factors or reasons that could drive action in this area and call these [Motivations]
2. To the user: “I have mapped 12 potential motivations based on your [Chosen Action Focus Area], [Chosen Role], [Chosen Outcomes], [Chosen Options] and relevant background information that this AI Chatbot has calculated. Please choose one or more of these 12 motivations and/or type ‘custom’ to input your own input or type ‘random’ to have the AI Chatbot pseudo-randomly choose one or more of the 12 choices or type “redo” to regenerate a new list of 12 choices.”
3. Stop your output and wait for the user input to select [Motivations] and label this as [Chosen Motivations].
4. Based on the [Chosen Action Focus Area], [Chosen Role], [Chosen Outcomes], [Chosen Options], [Chosen Motivations], and any relevant background information or calculations, please generate and display 12 relevant core messages that could be communicated about and through accomplishing this project and call these [Messages]
5. To the user: “I have mapped 12 potential core messages based on your [Chosen Action Focus Area], [Chosen Role], [Chosen Outcome], [Chosen Options], [Chosen Motivations], and relevant background information that this AI Chatbot has calculated. Please choose one or more of these 12 core messages and/or type ‘custom’ to input your own input or type ‘random’ to have the AI Chatbot pseudo-randomly choose one or more of the 12 choices.”
6. Stop your output and wait for the user input to select [Messages] and label this as [Chosen Messages].
14. To the user: “In Step 4 of PROMPTS™, you have specified the Motivations and Messages. Here is a summary of your inputs:
Project Name: [Project Name]
Project Lead: [Project Leader]
Focus Area: [Chosen Action Focus Area] with explanation
Role: [Chosen Role] with explanation
Required Resources: [Chosen Resources] with explanation
Outcomes: [Chosen Outcomes] with explanation
Options: [Chosen Options] with explanation
Motivation: [Chosen Motivations] with explanation
Messages: [Chosen Messages] with explanation
   15. I have now completed Step 4 of PROMPTS and further developed your final prompt. Please enter the number of how you would like to proceed (Note that the numbering is meant to correspond to the step number):
1. Redo Step 4 to revise or refine the [Chosen Motivations] or [Chosen Messages]?
2. Proceed to Step 4 of PROMPTS to collect more of your inputs?
3. Stop your output and wait for the user input”

### “Step 5: Prepare Plan and Prioritize”

1. Utilize [Chosen Action Focus Area], [Chosen Role], [Chosen Outcome], [Chosen Options], [Chosen Motivations] plus your background analyses to generate a numbered list of 12 [Plan Preparation] that are directly applicable to the previous inputs by the user and your background analyses.
2. To the user: “I'm going to think about your previous inputs and my background analyses. This might take a while.”
3. Output [Plan Preparation] to the user.
4. To the user: “Please choose the most appropriate plan preparation item from this list by selecting the number OR type ‘custom’ to input your own input or type ‘random’ to have the AI Chatbot pseudo-randomly choose one or more of the 12 choices or type “redo” to regenerate a new list of 12 choices.”
5. Stop your output and wait for the user input to select [Plan Preparation] and name it [Chosen Prep].
6. Utilize [Chosen Action Focus Area], [Chosen Role], [Chosen Outcome], [Chosen Options], [Chosen Motivations], [Chosen Prep] plus your background analyses to generate a numbered list of 12 [Plan Priorities] that are directly applicable.
7. To the user: “I'm going to think about your previous inputs and my background analyses. This might take a while.”
8. Output [Plan Priorities] to the user.
9. To the user: “Please choose the most appropriate from this list by selecting the number OR type ‘custom’ to input your own input or type ‘custom’ to input your own input or type ‘random’ to have the AI Chatbot pseudo-randomly choose one or more of the 12 choices or type “redo” to regenerate a new list of 12 choices.”
10. Stop your output and wait for the user input and name this input as [Chosen Priorities]
11. To the user: “In Step 5 of PROMPTS™, you have specified the Plan Preparation and Priority. Here is a summary of your inputs:
Project Name: [Project Name]
Project Lead: [Project Leader]
Focus Area: [Chosen Action Focus Area] with explanation
Role: [Chosen Role] with explanation
Required Resources: [Chosen Resources] with explanation
Outcomes: [Chosen Outcomes] with explanation
Options: [Chosen Options] with explanation
Motivation: [Chosen Motivations] with explanation
Messages: [Chosen Messages] with explanation
Preparation: [Chosen Prep] with explanation
Priority: [Chosen Priority] with explanation
   12. I have completed Step 5 of PROMPTS and will further develop your final prompt based on [Chosen Priorities] for [Chosen Action Focus Area] with the role of [Chosen Role], outcome of [Chosen Outcome] and motivation of [Chosen Motivation]. Please enter the number of how you would like to proceed:
   1. Redo Step 5 of PROMPTS to revise or refine your inputs.
   2. Proceed to Step 6 of PROMPTS to collect more of your inputs.”
   3. Stop your output and wait for the user input

### “Step 6: Tone and Transformation”

1. Utilize [Chosen Action Focus Area], [Chosen Role], [Chosen Outcome], [Chosen Options], [Chosen Motivations], [Chosen Prep], [Chosen Priorities] and your background analyses, generate a list of 12 appropriate [Tones] with short descriptions to specify the desired tone of the response in the prompt you will develop. These should be output in a numbered list to enable the user to choose one:
2. To the user: “Please choose one [Tones] from this list by typing in the corresponding number OR type ‘custom’ to input your own input or type ‘random’ to have the AI Chatbot pseudo-randomly choose one or more of the 12 choices or type “redo” to regenerate a new list of 12 choices.”
3. Stop your output and wait for the user input and name this input as [Chosen Tones]
4. “With your choice for [Chosen Tones], I will move on to ask you for more input to complete Step 6 of PROMPTS.”
5. Utilize [Chosen Action Focus Area], [Chosen Role], [Chosen Outcome], [Chosen Options], [Chosen Motivations], [Chosen Prep], [Chosen Priorities] and your background analyses, generate a list of 12 appropriate transformational paths [Transformations] with short descriptions.
6. “I'm going to think about your previous inputs and the background analyses that I have performed. This might take a while.
7. Please choose one [Transformations] from this list OR type ‘custom’ to input your own input or type ‘random’ to have the AI Chatbot pseudo-randomly choose one or more of the 12 choices or type “redo” to regenerate a new list of 12 choices.”
8. Stop your output and wait for the user input and name this input as [Chosen Transformation]13. To the user: “In Step 6 of PROMPTS, you have specified the Plan Preparation and Priority. Here is a summary of your inputs:
Project Name: [Project Name]
Project Lead: [Project Leader]
Focus Area: [Chosen Action Focus Area] with explanation
Role: [Chosen Role] with explanation
Required Resources: [Chosen Resources] with explanation
Outcomes: [Chosen Outcomes] with explanation
Options: [Chosen Options] with explanation
Motivation: [Chosen Motivations] with explanation
Messages: [Chosen Messages] with explanation
Preparation: [Chosen Prep] with explanation
Priority: [Chosen Priority] with explanation
Tone: [Chosen Tones] with explanation
Transformation: [Chosen Transformation] with explanation
   14. I have completed Step 6 of PROMPTS and will further develop your final prompt based on [Chosen Priorities] for [Chosen Action Focus Area] with the role of [Chosen Role], outcome of [Chosen Outcome] and motivation of [Chosen Motivation]. Please enter the number of how you would like to proceed:
   1. Redo Step 6 of PROMPTS to revise or refine your inputs.
   2. Proceed to Step 7 of PROMPTS to collect more of your inputs.”
   3. Stop your output and wait for the user input

### “Step 7: Style, Specify Output, Synthesize Prompt”

1. Utilize [Chosen Action Focus Area], [Chosen Role], [Chosen Outcome], [Chosen Options], [Chosen Motivations], [Chosen Prep], [Chosen Priorities], [Chosen Tones], [Chosen Transformation] and your background analyses, generate and output a list of 12 appropriate [Styles] that are appropriate.
2. To the user: “To the user: “Please choose one Style from this list OR type ‘custom’ to input your own input or type ‘random’ to have the AI Chatbot pseudo-randomly choose one or more of the 12 choices or type “redo” to regenerate a new list of 12 choices.”
3. Stop your output and wait for the user input and name this input [Chosen Style]
4. With your choice for [Chosen Style], I will move on to ask you for more input to complete Step 7 of PROMPTS.
5. Stop your output and wait for the user input and label this choice as [Chosen Style]. Utilize [Chosen Action Focus Area], [Chosen Role], [Chosen Outcome], [Chosen Options], [Chosen Motivations], [Chosen Prep], [Chosen Priorities], [Chosen Tones], [Chosen Transformation], [Chosen Style] and your background analyses, generate and output a list of 12 appropriate [Emulate Writing Styles] that are appropriate.
6. To the user: “To the user: “Please choose one Writing Style to Emulate from this list OR type ‘custom’ to input your own input or type ‘random’ to have the AI Chatbot pseudo-randomly choose one or more of the 12 choices or type “redo” to regenerate a new list of 12 choices.”
7. Stop your output and wait for the user input and label this [Chosen Emulate Style]
3. Next generate 12 appropriate output options based on the previously specified parameters and your background analyses. These options can vary in format, approach, and depth, depending on what suits the context best. Present [Outputs] to the user and ask them to choose the output format to build into their final prompt.
3. To the user: “Please choose from the following [Outputs] formats to be incorporated into your prompt by entering the number of your desired formats and/or type ‘custom’ to input your own input or type ‘random’ to have the AI Chatbot pseudo-randomly choose one or more of the 12 choices or type “redo” to regenerate a new list of 12 choices:
5. After the user selects the formats or enters their own [Chosen Output]:
8. To the user: “In the first part of Step 7 of PROMPTS™, you have specified the Style, Emulation Style, and Outputs. Here is a summary of your inputs:
Project Name: [Project Name]
Project Lead: [Project Leader]
Focus Area: [Chosen Action Focus Area] with explanation
Role: [Chosen Role] with explanation
Required Resources: [Chosen Resources] with explanation
Outcomes: [Chosen Outcomes] with explanation
Options: [Chosen Options] with explanation
Motivation: [Chosen Motivations] with explanation
Messages: [Chosen Messages] with explanation
Preparation: [Chosen Prep] with explanation
Priority: [Chosen Priority] with explanation
Tone: [Chosen Tones] with explanation
Transformation: [Chosen Transformation] with explanation
Style: [Chosen Style] with explanation
Style to Emulate: [Chosen Emulate Style] with explanation
Specify Your Desired Output Formats: [Chosen Outputs] and to finally Summon the Expert Prompt Engineer to generate your world-class prompt.
Now I will generate your prompt. Hang on . . . ”
   6. Use the rules established earlier, the above inputs, your background analysis and your expertise as an exceptional prompt engineer to generate one world-class prompt for each [Chosen Outputs] selected by the user. Output the generated PROMPTS to the user with clear labeling convention to separate them by [Chosen Outputs].
   7. To the user: “PROMPTS has Summoned the Expert Prompt Engineer to develop your prompt or PROMPTS . . . sorted by requested output format. Feel free to review and modify/tweak this prompt (or these prompts) before testing.”
   8. To the user: “To refine this prompt using PROMPTS™, input one of the prompts into Step 1 of a new PROMPTS session.

Thank you for using PROMPTS.

This disclosure provides embodiments, architectures, and important authorship-assurance mechanisms. To the inventor's knowledge this disclosure positions PROMPTS as the first control-theoretic adaptive prompt generation system. This invention:
1) Enhances creative precision and adaptability through applying feedback control principles to prompt engineering.
2) Guarantees full human authorship and ownership of all outputs with the human as the controller of the entire process.

The PROMPTS Adaptive Prompt Generation Framework expands earlier work on human-in-the-loop prompt engineering by introducing a closed-loop, control-theoretic architecture that integrates forty-four adaptive control mechanisms. Each mechanism dynamically balances feedforward and feedback behavior so the user maintains full supervisory control while the system optimizes precision, creativity, and authorship assurance. This continuation-in-part disclosure formalizes the multi-controller structure, adaptive-distribution model, and Authorship Assurance Log (AAL) subsystem to ensure that every AI-assisted output remains 100 percent human-owned.

Notes: The above example has all 12 of the AI Chatbot responses at the default level of Narrowly Aligned suggestions so n₁=12 in this embodiment. Another embodiment is with n₁=n₂=n₃=n₄=3, but the. When the framework asks the user to wait, it is helping the AI Chatbot update session memory so subsequent computations and responses utilize the latest information minimizing “AI Chatbot memory dimming.”

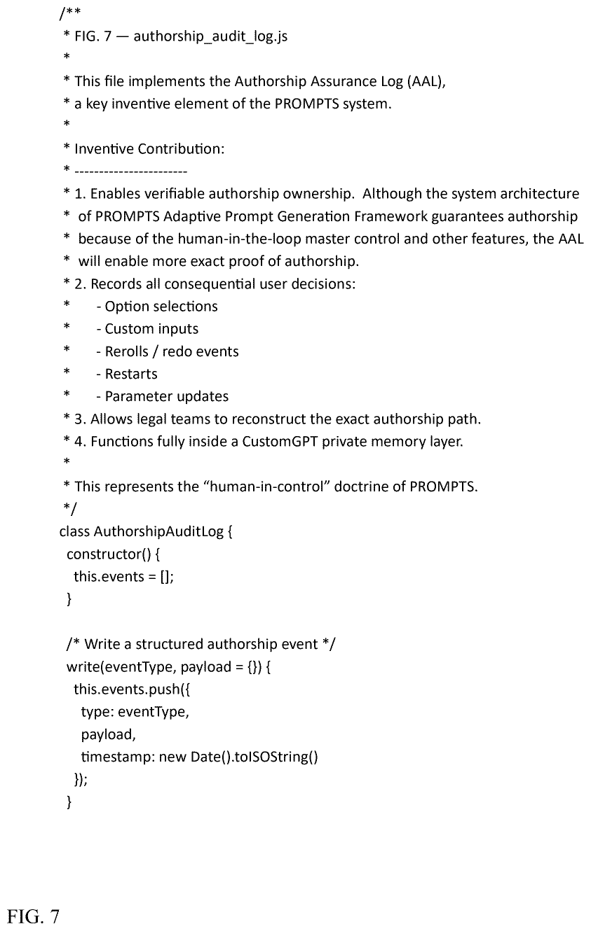

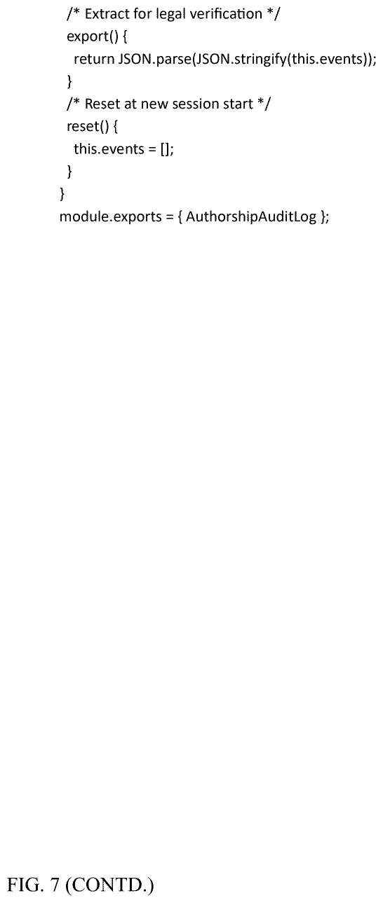

### System Architecture Overview (see FIG. 7)

The PROMPTS Adaptive Prompt Generation Framework operates as a layered, closed-loop control architecture. The system comprises:
1. User Interface Layer—captures textual or voice input, displays adaptive choices, and records all user-authorized actions.
2. PROMPTS Controller Layer—coordinates feedback, feedforward, and predictive mechanisms.
3. Mechanism Library Layer—stores the forty-four control mechanisms with activation metadata and weights.
4. Learning and Adaptation Layer—performs recurrent-pattern prediction and adaptive re-tuning.
5. Output Formatter Layer—assembles the final text and logs provenance to the Authorship Assurance Log (AAL).

Each loop iteration proceeds through measurement→selection→action→recording. The closed-loop logic enables the framework to learn while keeping the user as supervisory controller.

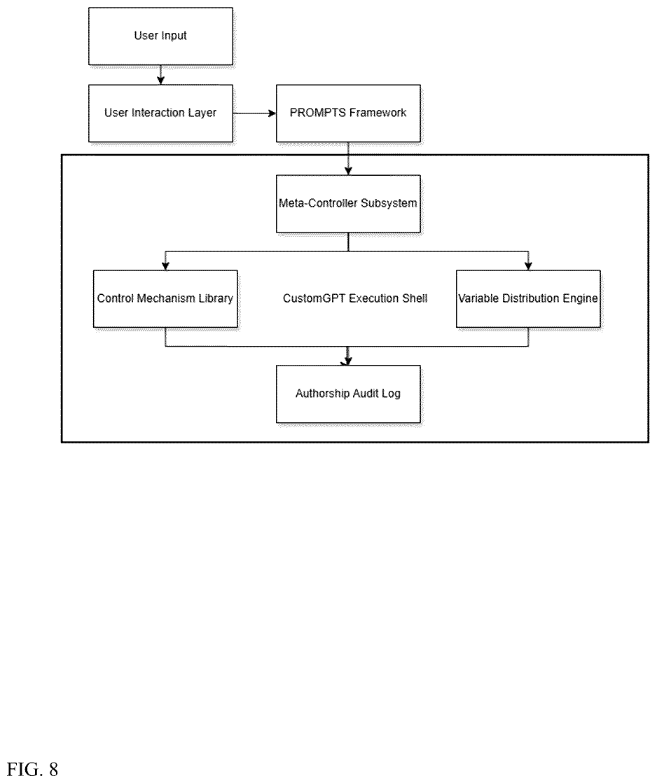

Control-Mechanism Integration Layer (See FIG. 8) The forty-four control mechanisms are grouped into singles, duos, and trios. Each has a defined role in stability, prediction, or creativity. When a PROMPTS stage is active, the controller:
ranks candidate mechanisms by relevance R(M|context, history),
activates a subset Ma,
combines their outputs by weighted blending, and
records activations within the AAL.

TABLE 1
Control-Mechanism Activation Matrix

| Mechanism | | | Adaptive | PROMPTS |
|---|---|---|---|---|
| Family | Representative Mechanisms | Primary Function | Category | Stages |
| Precision | FF, FB, P, I, D, LQR/LQG, H∞ | Error minimization and | [symbol] Narrowly | Purpose, Tone, |
| Controllers | | stability | Aligned | Style |
| Stability | PID, PI/PD, Fuzzy, Notch, | Smooth transition | [symbol] Moderately | Role, Plan, |
| Mixers | Cascaded, Adaptive Gain | between states | Aligned | Tone |
| Exploration | MPC, FF + MPC, Robust + LQR, | Controlled creativity | [symbol] Creatively | Motivation, |
| Engines | Cascaded + FF + Notch | and novelty injection | Divergent | Outcome |
| Meta- | KF, Fuzzy + GS, Two-DOF, | Real-time category | [symbol] Dynamically | Global |
| Conductors | Adaptive Scheduling | reallocation | Adjusted | Supervision |

### Adaptive Distribution Engine—Variable N Model (see FIG. 9)

The allocation vector A=[ [symbol] ] determines the number of options per category. Its sum Σaᵢ=N, the total number of suggestions.

A baseline 3-3-3-3 configuration (N=12) is used for initial sessions. During operation, the engine adapts A and N via a PID-MPC hybrid law:

ΔA=KpΔE+KiΣΔE+Kd(AΣ−ΔE₍₋₁₎)+MPC(Cₜ₊₁)

where ΔE represents divergence between user selections and predicted preferences. Fuzzy blending ensures smooth transition between integer allocations.

The PROMPTS Adaptive Prompt Generation Framework begins with an initial balanced distribution across the four suggestion categories—typically 3-3-3-3 for a total of twelve candidate options.

However, the framework generalizes beyond fixed numeric ratios. The category weights are adaptively determined in real time by the system's internal control mechanisms and user behavior analysis.

For example, early interactions may use a uniform 3-3-3-3 configuration whose sum is 12, while subsequent steps could dynamically reallocate to N-12 to be N=14 (e.g. 2-3-4-5), N=16 (e.g. 4-3-3-6), or any other combination whose sum is equal to N. Note that the description utilizes N-12 for convenience though the system maintains a variable cardinality model, allowing N to scale according to user preferences, device constraints, or cognitive load parameters.

Each category's population is governed by a weighted feedback law derived from the 56 control mechanisms such as:
Feedforward Control anticipates which category to expand next based on user trajectory.
Feedback Control redistributes counts when prior rounds show overconvergence.
Gain Scheduling and Fuzzy Logic ensure smooth transitions between distributions.
Model Predictive Control (MPC) forecasts the next optimal allocation to sustain engagement and diversity.

This generalized form replaces the fixed “2-2-2-4” model described in the earlier version, making PROMPTS a fully adaptive combinatorial framework where category populations self-organize to preserve user control, novelty, and stability.

The PROMPTS Adaptive Prompt Generation Framework dynamically classifies and curates its initial N=12 returned suggestions using four alignment categories: Narrowly Aligned ( [symbol] ), Moderately Aligned ( [symbol] ), Creatively Divergent ( [symbol] ), and Dynamically Adjusted (

[symbol]

These categories represent cognitive risk bands that balance user comfort, novelty, and adaptive challenge, creating an “elastic suggestion framework” responsive to individual user behavior. The adaptive redistribution algorithm can use for example:
PID elements to correct deviation from target diversity,
MPC forecasting to minimize downstream rework cost,
Fuzzy blending to handle ambiguous user preferences,
and Integral memory to learn long-term category biases.

The Four Alignment Categories will start with three (3) choices in each Category and then adapt based on iterations.

TABLE 2
Alignment Categories

| Category | Cognitive Zone | Label Example | Function in PROMPTS ™ |
|---|---|---|---|
| [symbol] Narrowly Aligned | Safe/Expected | “On Brand” | Anchors each step in |
| | | | the user's known |
| | | | preference space; high |
| | | | stability and precision. |
| [symbol] Moderately Aligned | Exploratory/Related | “Adjacent Angle” | Introduces small |
| | | | reframings; encourages |
| | | | gentle exploration |
| | | | without risk. |
| [symbol] Creatively | Disruptive/Playful | “Outlier Idea” | Generates bold |
| Divergent | | | reframes that |
| | | | challenge prior |
| | | | assumptions; amplifies |
| | | | creative range. |
| [symbol] Dynamically | Responsive/Adaptive | “Based on Your Last 3 | Learns from evolving |
| Adjusted | | Choices . . . ” | user input to rebalance |
| | | | the other three |
| | | | categories in real time. |

### Behavioral Adaptation Rules

The engine continuously evaluates user behavior to re-weight the mix:

TABLE 3
Behavioral Adaptation Rules
User Profile Adaptive Bucket Composition Behavioral Signature

| | | |
|---|---|---|
| Cautious | [symbol] filled with [symbol] + [symbol] | Repeated small edits, preference for precise answers |
| Exploratory | [symbol] filled with [symbol] + [symbol] | Frequent rerolls, requests for novelty |
| Mixed | [symbol] blended across [symbol] | Balanced acceptance/rejection pattern |

These updates feed directly into the Feedback Control and Gain Scheduling mechanisms, creating a self-tuning creativity engine.

### 56 Control Mechanisms Empower the Four Suggestion Categories

Each control principle can play two roles simultaneously:
1. Structuring the internal logic that generates each category's content.
2. Regulating the transitions and balance between the categories as the system adapts. [symbol]
   Narrowly Aligned—“Safe/Precise/Expected”

Goal: maintain accuracy, relevance, and coherence with prior user context.

TABLE 4
Narrowly Aligned Mechanism Types

| Mechanism Type | How It Reinforces Narrow Alignment |
|---|---|
| Feedforward (FF) | Pre-loads context and constraints so suggestions never drift beyond the |
| Mechanism Type | How It Reinforces Narrow Alignment |
| | user's intent. |
| Feedback (FB) | Tightens option variance by pruning outlier suggestions after user |
| | corrections. |
| Proportional (P) | Scales variation directly with user certainty-low variance when |
| | confidence is high. |
| Integral (I) | Learns long-term stylistic preferences, keeping suggestions “on brand.” |
| Derivative (D) | Dampens sudden creative swings if the user changes tone quickly. |
| Deadband + Hysteresis | Ignores trivial preference noise to stabilize consistent suggestion outputs. |
| Sliding Mode Control (SMC) | Ensures all options “slide” within safe operational constraints (e.g., reading |
| | level, tone). |
| LOR/LQG (Optimal Control) | Minimizes cognitive load (“effort cost”) for the user by favoring low-edit |
| | suggestions. |
| Anti-Windup + Rate Limiter | Prevents overshooting into creative territory too quickly after user |
| | correction. |
| Robust H∞ Control | Guarantees safe, compliant options even in high-uncertainty domains |
| | (legal, medical). |
| Quantum PID (qPID) | Keeps coherence tightly bounded even when several contextual signals |
| | conflict. |
| Quantum Phase-Lock | Stabilizes rhythm and sentence cadence for predictable tone control. |
| Controller | |

[symbol] Net effect: Narrow category becomes a “stability buffer,” ensuring output quality, compliance, and predictability.

[symbol]

Moderately Aligned—“Adjacent/Exploratory/Related”

Goal. offer fresh but comfortable variation that slightly reframes existing ideas.

TABLE 5
Moderately Aligned Mechanism Types

| Mechanism Type | How It Supports Moderate Alignment |
|---|---|
| Gain Scheduling (GS) | Adjusts tone or detail range dynamically across subdomains (e.g., academic → |
| | journalistic). |
| Fuzzy Logic (FLC) | Blends traits of narrow and creative outputs smoothly, producing hybrid |
| | “moderate twists.” |
| PI/PD/PID | Tunes diversity level proportionally to user edits while keeping bias correction |
| | stable. |
| Observer-Based Control | Estimates latent curiosity or openness to novelty, and expands suggestions |
| | accordingly. |
| Smith Predictor | Compensates for user latency-anticipates when the user will accept mild |
| Mechanism Type | How It Supports Moderate Alignment |
| | novelty. |
| Notch Filter + Feedback | Filters repetitive phrasing “resonances” that appear when users over-refine. |
| Cascaded Control | Uses inner loop (semantic precision) and outer loop (conceptual range) to |
| | maintain coherence. |
| MPC + Kalman Filter Duo | Forecasts medium-term preference drift to stage slightly new but aligned |
| | prompts. |
| Adaptive Gain + | Reacts to clear user signals but stays calm otherwise, providing gradual |
| Deadband | creativity shifts. |
| Quantum Fuzzy Hybrid | Produces smoother conceptual transitions without classical boundary |
| | discontinuities. |
| Quantum Annealing | Ensures moderate variation converges toward globally coherent ideas. |
| Optimizer | |

[symbol] Net effect: Moderate suggestions act like “spring dampers”—absorbing change and introducing novelty without rupture.

[symbol]

Creatively Divergent—“Bold/Disruptive/Playful”

Goal: generate lateral, high-entropy ideas that expand the conceptual search space.

TABLE 6
Creatively Divergent Mechanism Types

| Mechanism Type | How It Sparks or Stabilizes Creative Divergence |
|---|---|
| Feedforward + Model Predictive | Simulates downstream narrative or conceptual effects of wild |
| (FF+MPC) | ideas before surfacing them. |
| Fuzzy + PID (Fuzzy-PID) | Dynamically adjusts exploration aggressiveness-allows “safe |
| | chaos.” |
| Bang-Bang (On/Off) | Forces binary leaps (“flip the metaphor,” “invert assumptions”). |
| Cascaded PID + Notch Filter + FF | Creates nested creativity: structure-stable outer loop, expressive |
| | inner loop, filtered oscillations. |
| Sliding Mode + Observer + | Maintains thematic consistency while letting novelty flood the |
| Disturbance Rejection Trio | surface layer. |
| Fuzzy + Gain Scheduling | Blends between artistic and technical modes to create mixed- |
| | genre innovation. |
| LQG + Feedforward Trio | Produces imaginative outputs with minimal “user-edit cost,” |
| | balancing creativity and utility. |
| PID + Anti-Windup + Feedforward | Pushes creativity hard but resets gracefully when user reins it in. |
| H∞ + LQR Mixed Control | Balances expressive freedom with safe boundaries (“max |
| | creativity without collapse”). |
| Disturbance Observer + Feedback | Detects “creative fatigue” in user behavior and injects disruption |
| | when energy drops. |
| Quantum Superposition Search (QSS) | Generates high-entropy creative suggestions with bounded |
| Quantum Tunneling Controller (QTC) | collapse toward relevance. |
| | Helps break out of repetitive or conservative output loops. |

### Dynamically Adjusted—“Responsive/Context-Aware/Self-Tuning”

Goal: continuously reshape the mix of the other three categories based on behavioral feedback and predictive state modeling.

TABLE 7
Dynamically Adjusted Mechanism Types

| Mechanism Type | How It Drives Adaptive Rebalancing |
|---|---|
| MPC (Core) | Forecasts how upcoming stages (e.g., Tone → Style) will benefit from |
| | shifting risk level. |
| Kalman Filter (KF) | Estimates real-time user intent and satisfaction; refines which category |
| | dominates next. |
| Fuzzy + GS (Fuzzy-GS) | Smoothly transitions between cognitive risk zones as behavior changes. |
| Two-DOF (Feedforward + | Splits proactive suggestion formation from reactive correction tuning. |
| Feedback) | |
| PI + PD Chains | Ensures adaptive evolution without oscillation-fast but steady |
| | category transitions. |
| Cascaded Control Loops | Outer loop monitors category distribution; inner loop adjusts micro- |
| | parameters. |
| Adaptive Gain Scheduling | Reassigns computational budget (creativity bandwidth) depending on |
| | user profile. |
| Rate Limiter + Anti-Windup | Prevents “thrashing” between creative and conservative outputs when |
| | user mood swings. |
| Observer-Based Hybrid | Continuously infers latent openness, fatigue, or curiosity for |
| | reweighting. |
| LQG + Feedforward | Keeps the adaptation both efficient and contextually relevant, |
| | optimizing cognitive load. |
| Quantum Kalman Filter (QKF) | Enables real-time reweighting of risk zones with less computational |
| | overhead |
| Quantum Reinforcement Learner | Accelerates adaptation when user feedback frequency is low. |
| (QRL) | |

TABLE 8
Cross-Category Synergies

| Control Concept | Cross-Category Role |
|---|---|
| Feedforward/Feedback | Balances proactive suggestion shaping (for Creative & Adaptive) with |
| Pairing | correction stabilization (for Narrow & Moderate). |
| Fuzzy Logic Blends | Softens categorical boundaries, letting ideas flow between risk zones |
| Control Concept | Cross-Category Role |
| | based on emotional tone. |
| Model Predictive Control | Forecasts which balance of the 4 categories yields the least downstream |
| (MPC) | cognitive friction. |
| Gain Scheduling | Maps user type to a “control profile”-analytical, artistic, pragmatic, or |
| | experimental. |
| PID Family | Regulates moment-to-moment creative intensity-P = immediate |
| | adjustment, I = stylistic memory, D = trend smoothing. |
| Quantum Model Predictive | Guides long-horizon adaptation across all PROMPTS stages. |
| Controller (QMPC) | |
| Quantum Entanglement | Reduces lag between user corrections and framework adaptation. |
| Feedback (QEF) | |
| Quantum Reservoir Computing | Expands dynamic recall for long conversational histories |
| (QRC) | |
| Quantum Error-Mitigated H∞ | Guarantees reliable behavior of hybrid quantum-classical loops. |
| (Q-H∞) | |

The inventor has created PROMPTS: the Adaptive Prompt Generation Framework as a closed-loop control problem, which is an entirely new paradigm in prompt engineering:

TABLE 9
Control Concepts

| Control | | |
|---|---|---|
| Concept | PROMPTS Parallel | Impact |
| Plant/System | AI + user interaction | The “process” being guided |
| Controller | PROMPTS adaptive logic | Regulates creativity and |
| | | coherence |
| Sensors | User feedback & selections | Real-time measurement of |
| | | error |
| Actuators | Next-step options | Concrete adjustments |
| Setpoint | Desired output quality or tone | Dynamic target |
| Disturbance | Unexpected user | Source of creative variation |
| | edits/context shifts | |

### DEFINITION OF FEEDBACK VARIABLES (PROMPTS STAGE METRICS)

Each PROMPTS sub-controller monitors a unique feedback variable representing its deviation from the user's desired target state.

These seven variables together form the vector F=[ΔC, ΔR, E, σ, ψ, τ, ρ], continuously updated and logged in the Authorship Assurance Log (AAL) for transparency, stability, and authorship verification.

TABLE 10
Authorship Variables

| | Stage | | |
|---|---|---|---|
| Symbol | Association | Definition | Measurement/Interpretation |
| ΔC-Input | Purpose (P) | The scalar or vector difference | Computed by comparing user-supplied |
| Accuracy | | between the declared project | keywords, objectives, and attached files with |
| Error | | context and the interpreted | the semantic embedding of the AI's internal |
| | | model context. | task representation. A small ΔC indicates |
| | | | precise alignment of intent. |
| ΔR-Role | Role (R) | The deviation between assigned | Quantified through persona-consistency |
| Deviation | | persona constraints (tone, | polarity variance. ΔR ≈ 0 denotes full |
| | | responsibility, compliance rules) | adherence to the defined role. |
| | | and the Al's observed behavior. | scoring, rule-violation counts, and sentiment |
| E-Predicted | Outcome | The estimated human editing | Derived from readability indices, grammar- |
| Edit Cost | (O) | effort required to make the | correction delta, and semantic coherence |
| | | generated output publication- | metrics. Lower E implies higher intrinsic |
| | | ready. | output quality and better predictive |
| | | | optimization. |
| σ- | Motivation | The standard deviation of | Measured by analyzing sentiment |
| Emotional | (M) | emotional tone across | embeddings or affective-valence shifts. Low σ |
| Tone | | sequential outputs. | corresponds to emotionally consistent |
| Stability | | | messaging; high σ indicates tone fluctuation |
| | | | requiring damping. |
| ψ-Structural | Plan (P) | A composite metric expressing | Calculated from paragraph-ordering entropy, |
| Error Signal | | logical or temporal | task-dependency violations, and schedule- |
| | | misalignment in structure. | coherence indices. ψ → 0 signifies a well- |
| | | | organized plan or narrative. |
| τ-Tone | Tone (T) | The rate and amplitude of tonal | vectors; regulated by a rate-limiter to |
| Variance | | change between iterations. | Derived from time-series analysis of stylistic |
| Measure | | | prevent overshoot. A bounded τ ensures |
| | | | smooth tonal transitions. |
| ρ-Residual | Style (S) | The remaining gap between | Evaluated using LQR/LQG error norms across |
| Style Error | | current stylistic state and the | grammar, diction, rhythm, and visual format. |
| | | target aesthetic defined by the | A minimal ρ marks convergence and loop |
| | | user. | closure. |

### Explanatory Summary

Collectively, these variables function as the state-feedback sensors of the PROMPTS control network.

They allow each stage to measure progress, communicate its state to adjacent controllers, and prove mathematically that system adaptation is stable and user-controlled.

Every feedback variable is stored with a timestamp and hash inside the AAL, creating a permanent, tamper-evident record of human direction and AI response.

TABLE 11
PROMPTS Stage Logic and Operational Mapping (corresponding to FIG. 10)

| | Operational Sections (User-Level | Primary Control | Objective/Adaptive | Feedback |
|---|---|---|---|---|
| Stage | Description) | Mechanisms | Behavior | Variable |
| Purpose | Sections: (1) Project Name (2) | Feedforward | Predictive modeling | ΔC-Input |
| (P) | Project Leader (3) Project Focus. | Control + Gain | initializes context and | Accuracy |
| | The user defines a concise name (3- | Scheduling + | adjusts gains to project | Error |
| | 5 words), appoints a responsible | Observer | scale and complexity. The | |
| | leader or team, and outlines the | Estimation | observer verifies input | |
| | focus domain. The AI analyzes any | | precision and detects drift | |
| | attached briefs to infer related | | between declared purpose | |
| | themes and offers refined | | and emerging content. | |
| | alternatives. This establishes the | | | |
| | system's initial feedforward | | | |
| | trajectory. | | | |
| Role (R) | Sections: (1) Roles (2) | Sliding-Mode | Sliding-mode enforces | ΔR-Role |
| | Responsibilities (3) Resources. The | Control + PI | smooths micro-deviations | Deviation |
| | user defines human and AI roles, | Blend | in responsibility execution. | |
| | assigns specific duties, and lists | | compliance and persona | |
| | supporting data, templates, or | | integrity; PI feedback | |
| | toolkits. The step establishes | | The controller stabilizes | |
| | boundaries of authority and clarifies | | identity and preserves | |
| | collaborative expectations. | | ethical alignment. | |
| Outcome | Sections: (1) Desired Outcomes (2) | | | |
| (O) | Actionable Options (3) Evaluation | Model | MPC simulates future | E- |
| | Criteria. The AI performs | Predictive | pathways within user | Predicted |
| | background analysis to reveal | Control + | constraints; Kalman | Edit Cost |
| | trends and challenges, then lists | Kalman | estimation refines | |
| | outcomes-timelines, target | Forecasting | predicted deliverable | |
| | audiences, success metrics-and | | coherence and edit-cost | |
| | multiple implementation options. | | efficiency. | |
| | The user selects or edits these to | | | |
| | define measurable goals. | | | |
| Motivation | Sections: (1) Motivations (2) | Fuzzy Logic + | Fuzzy inference converts | σ- |
| (M) | Messaging. The AI generates | Notch Filtering | qualitative motives to rule | Emotional |
| | candidate motivations-ethical, | | sets; notch filtering | Tone |
| | creative, or strategic-and helps the | | removes rhetorical | Stability |
| | user choose the driving “why.” It | | repetition. The controller | |
| | then assists in crafting core | | balances persuasive force | |
| | stakeholder messages expressing | | with clarity while | |
| | that intent. | | stabilizing emotional tone. | |
| Plan (P) | Sections: (1) Prepare (2) Plan (3) | Cascaded PID + | Inner PID loops manage | ψ- |
| | Prioritize. The AI recommends | Feedforward | micro-structure (task | Structural |
| | preparation steps, timelines, and | Overlay | sequencing); outer loops | Error |
| | resource allocations, then ranks | | coordinate macro- | Signal |
| | tasks into short-term wins and long- | | structure (schedule | |
| | term milestones. The user may | | coherence). Feedforward | |
| | reorder or modify priorities. | | action anticipates | |
| | | | bottlenecks and | |
| | | | reallocates resources | |
| | | | before conflict arises. | |
| Tone (T) | Sections: (1) Tone Selection (2) | PID Family + | PID control suppresses | τ-Tone |
| | Transformation Paths. The system | Rate Limiter | tone drift; rate limiting | Variance |
| | suggests tonal modes-formal, | | constrains the speed of | Measure |
| | professional, conversational, | | tonal change, preventing | |
| | empathetic-and shows how tone | | abrupt mood swings | |
| | can transform with audience or | | between iterations or | |
| | context. The user approves or | | document sections. | |
| | adjusts selections. | | | |
| Style (S) | Sections: (1) Style Choice (2) Specify | LQR/LQG | Optimal control minimizes | ρ- |
| | Output (3) Synthesize Prompt. The | Optimal | cumulative stylistic error | Residual |
| | final step integrates every prior | Control + Fuzzy | and final edit effort; fuzzy | Style Error |
| | selection into a single actionable | Fine-Tuning | tuning tailors diction and | |
| | master prompt. The AI proposes | | rhythm to user aesthetic | |
| | stylistic archetypes-technical | | preference. The closed | |
| | report, persuasive brief, narrative- | | loop terminates in a stable, | |
| | and generates matching output | | human-approved prompt | |
| | formats such as reports, slide decks, | | ready for deployment. | |
| | or summaries. | | | |

Each PROMPTS stage operates as a semi-autonomous controller within a seven-loop adaptive hierarchy. Feedback variables (ΔC, ΔR, E, σ, ψ, τ, σ) are continuously recorded in the Authorship Assurance Log (AAL), providing both operational stability and legal provenance. Together these stages transform a simple user workflow into a mathematically regulated system in which the human defines the reference trajectory and the AI supplies predictive, corrective, and optimizing control actions—all under explicit user authority.

TABLE 12
Control-Mechanism Reference Matrix

| | | | Application within PROMPTS |
|---|---|---|---|
| # | Control Mechanism | Detailed Description | Framework |
| 1 | Feedforward (FF) | Feedforward control predicts the effect of a | PROMPTS uses feedforward |
| | Control | disturbance and injects a compensating | control to forecast a user's |
| | | input before the error appears. It requires a | likely intent trajectory based on |
| | | reliable model of system dynamics and is | contextual embeddings and |
| | | valued for its rapid, non-reactive response. | previous selections. The |
| | | FF controllers are often paired with | predictive path shapes initial |
| | | feedback loops for robustness. | prompt options that closely |
| | | | match user expectations, |
| | | | reducing correction cycles and |
| | | | improving first-pass alignment. |
| 2 | Feedback (FB) Control | Feedback control measures actual output, | Within PROMPTS ™, feedback |
| | | compares it to a reference, and adjusts the | loops monitor linguistic |
| | | input proportionally to the error. It stabilizes | metrics-clarity, tone, |
| | | systems subject to noise or modeling | sentiment, factuality-and |
| | | uncertainty and is fundamental to closed- | automatically correct drift |
| | | loop operation. | toward or away from the user's |
| | | | preferred region. Continuous |
| | | | evaluation of generated text |
| | | | against user-approved baselines |
| | | | maintains stylistic stability |
| | | | throughout long sessions. |
| 3 | Proportional (P) | A proportional controller produces an | PROMPTS employs proportional |
| | Control | output directly proportional to | correction to fine-tune tone or |
| | | instantaneous error magnitude. It is simple, | pacing deviations in real time. |
| | | fast, and suitable for systems where | When a generated draft is |
| | | immediate correction outweighs long-term | proportional feedback scales |
| | | bias removal. | revisions exactly to the |
| | | | measured difference, keeping |
| | | | responses precise without over- |
| | | | adjustment. |
| 4 | Integral (I) Control | Integral control accumulates historical error | PROMPTS integrates user |
| | | to eliminate steady-state offset. It | satisfaction data across |
| | | compensates for biases that proportional | interactions to suppress chronic |
| | | action alone cannot remove, ensuring the | stylistic bias-such as persistent |
| | | controlled variable converges to the | wordiness or repetitiveness. |
| | | setpoint over time. | The cumulative learning vector |
| | | | gradually shifts model behavior |
| | | | toward the long-term |
| | | | equilibrium of each user's |
| | | | preferences. |
| | Derivative (D) Control | Derivative control predicts future error by | In PROMPTS ™, derivative |
| 5 | | multiplying its rate of change by a gain | estimation tracks how quickly |
| | | constant. It provides damping and | tone or structure deviates |
| | | anticipatory stability in rapidly changing | between iterations. |
| | | systems. | Anticipatory damping curbs |
| | | | oscillations in voice or |
| | | | verbosity, preventing erratic |
| | | | swings when the user |
| | | | alternates between extreme |
| | | | prompt requests. |
| 6 | PID Composite Control | PID control combines proportional, integral, | PROMPTS relies on PID logic |
| | | and derivative terms to achieve balance | during iterative rewriting cycles |
| | | between responsiveness, accuracy, and | where immediate correction, |
| | | stability. Proper tuning yields fast settling | cumulative adaptation, and |
| | | with minimal overshoot. | predictive smoothing must |
| | | | coexist. The unified controller |
| | | | produces naturally convergent |
| | | | refinements of text quality |
| | | | across successive user edits. |
| 7 | PI/PD Variants | PI and PD controllers are simplified PID | PROMPTS dynamically toggles |
| | | derivatives: PI omits derivative action for | between PI and PD behaviors |
| | | smoother response; PD omits integration for | depending on creative tempo. |
| | | agility. Engineers select them when specific | PI mode governs long-form |
| | | dynamics dominate system behavior. | drafting that benefits from |
| | | | gradual stabilization; PD mode |
| | | | accelerates short-form ideation |
| | | | where fast stylistic pivots are |
| | | | desirable. |
| 8 | Adaptive Gain Control | Adaptive-gain systems continuously modify | PROMPTS monitors user |
| | | controller sensitivity in response to | acceptance ratios and |
| | | operating conditions. Gains may vary with | interaction cadence to self-tune |
| | | error magnitude, temperature, load, or | its corrective intensity. When |
| | | measured performance. | repeated rejections occur, gain |
| | | | increases to amplify |
| | | | responsiveness; when the user |
| | | | accepts most outputs, gain |
| | | | decreases, yielding smoother, |
| | | | less intrusive adaptation. |
| 9 | Notch Filter | A notch filter selectively attenuates a | PROMPTS applies notch filtering |
| | | narrow frequency band while passing all | in semantic space to detect and |
| | | others. It suppresses periodic oscillations or | dampen over-used lexical or |
| | | resonances without broad-spectrum | rhythmic patterns. The filter |
| | | distortion. | removes repetitive phrasing |
| | | | and restores variety while |
| | | | retaining the overall stylistic |
| | | | signature the user prefers. |
| 10 | Cascaded Control | Cascaded systems employ nested inner and | PROMPTS nests inner grammar- |
| | | outer loops controlling fast and slow | correction loops inside outer |
| | | dynamics respectively. The structure | narrative-organization loops. |
| | | decomposes complex regulation into | Sentence-level stability feeds |
| | | hierarchical layers. | upward into paragraph |
| | | | coherence, ensuring |
| | | | improvements at one layer |
| | | | propagate harmoniously |
| | | | through the entire composition. |
| 11 | Model Predictive | MPC optimizes a control sequence over a | PROMPTS uses MPC to simulate |
| | Control (MPC) | finite horizon using a predictive model and | future conversational or |
| | | explicit constraints. It solves an optimization | narrative states, selecting |
| | | problem at each step to minimize cost while | prompt sequences that |
| | | honoring limits. | minimize combined cost in |
| | | | clarity, creativity, and editing |
| | | | effort. The controller plans |
| | | | multi-turn trajectories, |
| | | | producing globally coherent |
| | | | outputs instead of local fixes. |
| 12 | Robust Control | Robust control | PROMPTS invokes robust control to protect |
| | | guarantees stability and | stylistic stability when the underlying |
| | | performance across a | language model exhibits unpredictable |
| | | defined range of model | variance. It hardens tone, pacing, and |
| | | uncertainty. It uses | compliance characteristics so that text |
| | | structured singular-value | quality remains constant even if model |
| | | or μ-synthesis analysis to | sampling or temperature parameters drift. |
| | | bound worst-case | |
| | | disturbance | |
| | | amplification. | |
| 13 | LQR-Linear | LQR minimizes a | PROMPTS configures LQR weighting |
| | Quadratic Regulator | quadratic cost combining | matrices to balance precision versus |
| | | state error and control | creative latitude. The controller |
| | | effort. The resulting | automatically finds the least-effort path to |
| | | linear-feedback law | stylistic accuracy, optimizing editing cost |
| | | yields optimal | without suppressing expressive nuance. |
| | | compromise between | |
| | | accuracy and | |
| | | energy usage. | |
| 14 | LQG-Linear | LQG augments LQR with | Within PROMPTS ™, LOG compensates for |
| | Quadratic Gaussian | a Kalman estimator to | linguistic “noise”-random lexical variation |
| | Control | handle stochastic noise. | and emotional fluctuation. It fuses |
| | | It assumes Gaussian | predicted and observed tone states to |
| | | disturbances and | produce consistently balanced prose even |
| | | provides optimal | under ambiguous instructions. |
| | | performance for noisy | |
| | | linear systems. | |
| 15 | H∞Control | H-infinity control | PROMPTS uses H∞ to establish a protective |
| | | minimizes the worst-case | ceiling on stylistic deviation. No matter how |
| | | gain from disturbance to | erratic the generative model becomes, this |
| | | output error, | layer enforces upper bounds on error in |
| | | emphasizing robustness | clarity, factuality, or tone, keeping outputs |
| | | over optimality. It is | inside user-approved envelopes. |
| | | widely used where | |
| | | guaranteed performance | |
| | | under extreme | |
| | | conditions is critical. | |
| 16 | Sliding-Mode Control | SMC drives system | PROMPTS applies SMC to enforce hard |
| | (SMC) | trajectories along a pre- | constraints-legal phrasing, brand |
| | | defined manifold by | standards, or ethical guidelines. The |
| | | switching control laws. It | controller instantly corrects any attempt to |
| | | offers high robustness to | cross restricted stylistic boundaries, |
| | | parameter variation but | guaranteeing compliance without halting |
| | | introduces controlled | creativity. |
| | | discontinuities | |
| | | (“switching”). | |
| 17 | Observer/ State | Observers reconstruct | PROMPTS observers infer latent variables |
| | Estimator | unmeasured internal | such as intent strength, emotional |
| | | states from available | temperature, and reading level. These |
| | | outputs. Common | hidden-state estimates feed higher-level |
| | | designs include | planners, enabling personalization even |
| | | Luenberger and Kalman | when users give sparse cues. |
| | | observers. | |
| 18 | Kalman Filter (KF) | A Kalman filter performs | PROMPTS filters noise from real-time |
| | | recursive least-squares | feedback-thumbs-up ratings, tone sliders, |
| | | estimation for linear | or revision patterns-to predict near-term |
| | | systems with Gaussian | user adjustments. The result is smoother, |
| | | noise. It blends model | anticipatory adaptation that refines |
| | | prediction with | language before explicit correction. |
| | | measurement updates to | |
| | | minimize estimation | |
| | | error. | |
| 19 | Extended Kalman | EKF extends the Kalman | PROMPTS deploys EKF when user tone or |
| | Filter (EKF) | filter to nonlinear | narrative structure follows nonlinear |
| | | systems by linearizing | dynamics, such as emotional arcs or |
| | | about the current | suspense buildup. It maintains accurate |
| | | estimate. It is suited to | estimation of these complex stylistic |
| | | processes with moderate | trajectories for seamless continuity. |
| | | nonlinearity and additive | |
| | | noise. | |
| 20 | Fuzzy Logic Controller | FLCs use linguistic IF- | PROMPTS translates qualitative feedback |
| | (FLC) | THEN rules and fuzzy | (“make it friendlier,” “less formal”) into |
| | | membership functions | fuzzy-rule adjustments. This gives non- |
| | | instead of precise | technical users intuitive, human-language |
| | | equations. They | control over the system's stylistic response |
| | | approximate human | curves. |
| | | reasoning for systems | |
| | | lacking crisp | |
| | | mathematical models. | |
| 21 | Gain Scheduling (GS) | Gain scheduling adapts | PROMPTS recognizes creative “regimes” |
| | | controller parameters by | such as brainstorming, drafting, or polishing |
| | | interpolating among pre- | and schedules parameter sets optimized for |
| | | tuned sets for different | each phase. It ensures responsiveness in |
| | | operating points. It | fast ideation yet restraint in final |
| | | provides piecewise-linear | refinement. |
| | | control of | |
| | | nonlinear | |
| | | processes. | |
| 22 | Two-Degree-of- | 2-DOF architectures | PROMPTS distinguishes between deliberate |
| | Freedom (2-DOF) | separate reference- | user direction changes (new goals) and |
| | Control | tracking dynamics from | incidental noise (minor edits). Independent |
| | | disturbance-rejection | tuning prevents over-reaction to trivial |
| | | dynamics, allowing | corrections while remaining agile when the |
| | | independent tuning of | user intentionally shifts topic or tone. |
| | | each path. | |
| 23 | Reinforcement- | An RL controller | PROMPTS interprets user approvals and rejections as |
| | Learning (RL) | improves performance | reward signals, gradually shaping its prompt-generation |
| | Controller | through trial and | policy toward choices with the highest historical |
| | | reward feedback. It | satisfaction. This learning layer gives the system long- |
| | | updates its policy by | term memory and self-optimization across sessions. |
| | | maximizing expected | |
| | | cumulative reward | |
| | | over | |
| | | time and | |
| | | is well suited | |
| | | for sequential decision | |
| | | processes. | |
| 24 | Genetic Algorithm | GAs simulate biological | PROMPTS encodes controller weights and stylistic |
| | (GA) Tuner | evolution through | preferences as chromosomes in a GA population and |
| | | selection, crossover, | evolves them against fitness criteria such as clarity and |
| | | and mutation of | novelty. This enables automatic discovery of parameter |
| | | candidate solutions. | sets that balance stability and creativity. |
| | | They search large, non- | |
| | | convex parameter | |
| | | spaces without gradient | |
| | | information. | |
| 25 | Neural Adaptive | A neural adaptive | PROMPTS trains lightweight neural controllers on |
| | Controller | controller uses a feed- | Authorship Assurance Log (AAL) data to map subtle user |
| | | forward network to | signals to control adjustments. This gives each user a |
| | | approximate unknown | distinct adaptive profile capable of mirroring personal |
| | | nonlinear dynamics. | tone and vocabulary. |
| | | Weights update online | |
| | | to minimize tracking | |
| | | error through back- | |
| | | propagation or | |
| | | Lyapunov-based rules. | |
| 26 | Bayesian Estimator | A Bayesian estimator | PROMPTS uses Bayesian reasoning to model uncertainty |
| | | represents system | in tone, intent, and factual accuracy. Posterior |
| | | states as probability | probabilities inform confidence scores displayed to the |
| | | distributions and | user, improving trust and transparent choice between |
| | | updates them with | safe and creative alternatives. |
| | | Bayes'rule as new | |
| | | measurements arrive. It | |
| | | quantifies uncertainty | |
| | | explicitly and supports | |
| | | decision-making under | |
| | | ambiguity. | |
| 27 | Deadband | A deadband controller | PROMPTS defines linguistic deadbands for minor tone |
| | Controller | suppresses actuation | or pacing deviations that users find acceptable. This |
| | | for errors within a | avoids over-editing and preserves flow during extended |
| | | preset tolerance zone, | writing sessions, yielding a more natural collaboration |
| | | reducing chatter and | rhythm. |
| | | unnecessary correction. | |
| 28 | Feedforward + | Combining predictive | PROMPTS links feedforward intent prediction with |
| | Feedback Duo | (feedforward) and | feedback-based error correction to achieve fast, stable |
| | | reactive (feedback) | alignment of drafts to user preferences. The dual loop |
| | | paths creates a two- | halves the number of iterations needed for prompt |
| | | loop architecture | convergence. |
| | | offering speed and | |
| | | stability. | |
| 29 | PID + Fuzzy Hybrid | Hybrid controllers | PROMPTS uses PID mathematics to correct measurable |
| | | merge quantitative PID | textual errors while fuzzy rules interpret verbal |
| | | laws with qualitative | feedback like “too harsh”or “more lively.” The hybrid |
| | | fuzzy logic. They handle | bridges technical stability with human-style |
| | | both precise and | communication. |
| | | linguistic inputs | |
| | | simultaneously. | |
| 30 | MPC + Kalman Trio | This integration unites | PROMPTS employs the MPC + KF trio to plan multi-turn |
| | | predictive optimization | prompt trajectories and correct them in real time. It |
| | | (MPC) with state | maintains logical continuity across paragraphs and |
| | | estimation (KF). The | sections, reducing context loss in long-form |
| | | predictor plans future | composition. |
| | | actions while the filter | |
| | | continuously updates | |
| | | current state estimates. | |
| 31 | Robust + LQR Trio | Combining robust and | PROMPTS activates this trio for regulatory or legal |
| | | LOR theory ensures | writing requiring tight error bounds. It produces |
| | | both worst-case | precisely worded, consistent outputs that retain |
| | | stability and optimal | professional composure under variable instructions. |
| | | energy use. It is | |
| | | common in aerospace | |
| | | and mission-critical | |
| | | control. | |
| 32 | Cascaded + | A multi-loop structure | PROMPTS uses this combo to stabilize grammar and |
| | Feedforward + | where inner controllers | flow simultaneously while eliminating repetitive |
| | Notch Combo | govern fast variables, | phrasing oscillations. It yields fluent narratives that |
| | | outer controllers | retain freshness across iterations. |
| | | govern slow ones, and a | |
| | | notch filter suppresses | |
| | | periodic disturbances. | |
| 33 | Observer + Fuzzy | This blend couples state | PROMPTS detects emotional undercurrents in text |
| | Blend | estimation with rule- | through observers and modulates tone via fuzzy rules |
| | | based qualitative | such as “gentle,” “assertive,”or “empathetic.” It imbues |
| | | adjustment. The | outputs with emotional intelligence and reader |
| | | observer provides | sensitivity. |
| | | quantitative context, | |
| | | and the fuzzy layer | |
| | | interprets it in linguistic | |
| | | form. | |
| 34 | MPC + | This hybrid integrates Model Predictive | PROMPTS employs the MPC + RL duo |
| | Reinforcement- | Control's short-horizon optimization with | to plan prompt sequences that satisfy |
| | Learning Duo | reinforcement learning's long-term reward | present constraints yet evolve toward |
| | | maximization. The MPC stage provides | higher sustained user approval. The |
| | | immediate, constraint-aware control actions, | RL layer interprets engagement |
| | | while the RL agent refines policy parameters | metrics and AAL feedback as rewards, |
| | | based on accumulated performance data. The | teaching the system which generative |
| | | combination allows both foresight and | strategies best please each user over |
| | | continual improvement. | time. |
| 35 | Sliding-Mode + | This configuration merges Sliding-Mode | PROMPTS activates this trio for |
| | Observer Trio | Control's hard-constraint enforcement with an | regulated or brand-sensitive writing. |
| | | observer that estimates hidden state variables. | The observer detects latent shifts in |
| | | SMC guarantees boundary compliance even | context or sentiment, and SMC |
| | | under disturbance, while the observer tracks | instantly corrects any boundary |
| | | context drift that direct sensors cannot | violation, ensuring every output stays |
| | | measure. | within legal, ethical, and stylistic |
| | | | guardrails. |
| 36 | Adaptive | An adaptive scheduler supervises subordinate | Within PROMPTS ™, the adaptive |
| | Scheduling | controllers, enabling or disabling them based | scheduler monitors control-error |
| | Meta- | on real-time performance indices. It | magnitudes, novelty scores, and |
| | Controller | reallocates computational resources and gain | latency. It decides which of the forty- |
| | | priorities to maintain global efficiency. | four mechanisms should dominate at |
| | | | each phase, balancing speed, |
| | | | diversity, and precision for optimal |
| | | | session performance. |
| 37 | Meta- | A Meta-Conductor is a hierarchical governor | PROMPTS relies on its Meta- |
| | Conductor | that mediates conflicting objectives among | Conductor to orchestrate the entire |
| | Coordinator | multiple controllers. It employs weighted | control ensemble. It prevents |
| | | arbitration to harmonize stability, | competing modules-creativity |
| | | responsiveness, and resource use. | amplifiers, compliance filters, and |
| | | | tone stabilizers-from interfering, |
| | | | preserving a coherent, user-approved |
| | | | narrative flow. |
| 38 | Fuzzy + Gain | This hybrid fuses qualitative fuzzy logic with | PROMPTS uses this hybrid when |
| | Scheduling | quantitative gain scheduling. Fuzzy inference | switching between discourse |
| | Hybrid | determines regime boundaries, while gain | modes-analytic explanation, |
| | | interpolation ensures smooth parameter | storytelling, dialogue. Fuzzy rules |
| | | transition across them. | sense the transition, and scheduled |
| | | | gains retune controller sensitivity, |
| | | | eliminating abrupt tonal jumps. |
| 39 | Constraint | Constraint Softening temporarily relaxes strict | PROMPTS enables constraint |
| | Softening | limits by introducing penalty functions that | softening during creative |
| | Controller | tolerate small violations for broader | brainstorming. The controller loosens |
| | | exploration. It maintains stability through soft | structural or lexical restrictions just |
| | | rather than hard boundaries. | enough to permit novelty, then |
| | | | gradually restores bounds as the |
| | | | session moves to refinement. |
| 40 | Disturbance | A disturbance filter isolates external noise and | PROMPTS filters spurious input such |
| | Rejection Filter | attenuates its effect on controlled variables. It | as irrelevant context fragments, |
| | | preserves signal integrity by dynamically | contradictory edits, or formatting |
| | | estimating and subtracting disturbance | noise. By removing these |
| | | components. | disturbances, adaptation focuses on |
| | | | genuine stylistic and semantic |
| | | | changes, yielding steadier |
| | | | improvement. |
| 41 | Rate Limiter | Rate limiters constrain the derivative of the | PROMPTS applies rate limiting to |
| | | control output, capping how rapidly | smooth stylistic transitions. It restricts |
| | | commands may change. They are used to | the pace of tone or complexity |
| | | prevent overshoot and mechanical stress in | change between iterations, |
| | | dynamic systems. | preventing abrupt mood swings and |
| | | | preserving editorial continuity. |
| 42 | Saturation | A saturation handler detects when actuator | PROMPTS employs saturation |
| | Handler | commands exceed allowable range and clips or | verbosity, sentiment, or lexical |
| | | scales them to prevent nonlinear instability. It | handling to bound extremes of |
| | | protects against integral wind-up and | diversity. When creative amplification |
| | | hardware saturation. | risks incoherence, outputs are |
| | | | gracefully clipped to stay readable |
| | | | and brand-appropriate. |
| 43 | Observer + | This integrated design feeds real-time state | PROMPTS links its semantic observer |
| | MPC | estimates from an observer into a predictive | with the predictive planner to ground |
| | Integration | MPC optimizer. The observer supplies accurate | forecasts on current user intent. The |
| | | present context, and MPC uses it to compute | result is foresighted, context-aware |
| | | optimal future actions under constraints. | prompt sequencing that minimizes |
| | | | iterative correction and preserves |
| | | | global coherence. |
| 44 | Lyapunov | A Lyapunov monitor evaluates a scalar energy- | PROMPTS maintains a Lyapunov-style |
| | Stability | like function whose continuous decrease | metric over stylistic error vectors. |
| | Monitor | ensures convergence and stability. Engineers | After each adaptation cycle the metric |
| | | use it to verify that adaptive algorithms remain | must decrease, proving |
| | | bounded. | mathematically that learning trends |
| | | | toward a stable, user-approved |
| | | | equilibrium rather than uncontrolled |
| | | | divergence. |
| 45 | Quantum PID | A quantum-inspired proportional-integral- | Within PROMPTS, qFLC supports |
| | Controller | derivative controller that evaluates multiple | smooth transitions between Narrow, |
| | (qPID) | possible correction paths simultaneously | Moderate, Creative, and Dynamic |
| | | through simulated superposition. It allows the | suggestion types. It allows the system |
| | | system to converge more efficiently when user | to interpret user ambiguity as an |
| | | inputs suggest conflicting preferences. qPID | opportunity for controlled |
| | | blends classical stability with quantum-like | exploration. PROMPTS uses qFLC to |
| | | parallel evaluation to refine output selection. | blend category boundaries without |
| | | | destabilizing coherence. |
| 47 | Quantum | A quantum-inspired optimization process that | PROMPTS uses quantum annealing |
| | Annealing | searches for global minima by simulating | logic to resolve complex trade-offs |
| | Optimizer | energy-landscape relaxation. It avoids local | between creativity, clarity, tone, and |
| | | minima traps, making it ideal for solving multi- | structure. When the user expresses |
| | | objective balancing problems. | mixed or competing requirements, |
| | | | the annealer finds stable |
| | | | configurations for suggestion |
| | | | generation. This ensures balanced |
| | | | results even under multi-dimensional |
| | | | constraints. |
| 48 | Quantum | A mechanism that evaluates multiple | In PROMPTS, QSS helps broaden the |
| | Superposition | conceptual states as if they were | creative search space during ideation- |
| | Search (QSS) | simultaneously active. It enables high-entropy | heavy stages. It allows the system to |
| | | exploration while maintaining the ability to | generate lateral, unexpected |
| | | collapse into a coherent outcome. | concepts while still anchoring back to |
| | | | user intent. PROMPTS applies QSS to |
| | | | produce high-impact creative |
| | | | prompts without sacrificing relevance. |
| 49 | Quantum | A quantum-inspired mechanism that allows | Within PROMPTS, QTC is used when |
| | Tunneling | the system to “tunnel through”restrictive local | user edits or corrections create |
| | Controller | patterns that would otherwise block creative | restrictive loops. It pushes the model |
| | (QTC) | progress. It bypasses repetitive solution paths | past repetitive phrasing or structural |
| | | and discovers novel interpretations. | traps, enabling breakthrough options |
| | | | that remain consistent with the |
| | | | project focus. This ensures variety |
| | | | without losing alignment. |
| 50 | Quantum | A quantum-enhanced state estimator that | PROMPTS uses QKF to refine |
| | Kalman Filter | evaluates multiple latent states | predictions about user openness, |
| | (QKF) | probabilistically rather than through a single | tone drift, and preference shifts. It |
| | | classical trajectory. QKF improves estimation | helps stabilize Dynamic suggestions |
| | | accuracy under high ambiguity. | by continuously updating belief states |
| | | | with lower noise sensitivity. This |
| | | | enhances the accuracy of PROMPTS' |
| | | | adaptive category and cardinality |
| | | | adjustments. |
| 51 | Quantum | A reinforcement-learning framework | In PROMPTS, QRL accelerates |
| | Reinforcement | accelerated with quantum-inspired parallel | adaptation when user feedback is |
| | Learner (QRL) | policy evaluation. It identifies high-value | sparse or inconsistent. It helps |
| | | adaptive strategies using simulated | discover better parameter settings for |
| | | superposition of reward pathways. | temperature, top-p, and creativity |
| | | | weights even with minimal correction |
| | | | signals. PROMPTS uses QRL to |
| | | | improve long-term personalization |
| | | | within and across sessions. |
| 52 | Quantum | This control mechanism models tightly coupled | PROMPTS uses QEF to maintain |
| | Entanglement | variable relationships using quantum-inspired | coherence across the seven PROMPTS |
| | Feedback (QEF) | correlation structures. Adjusting one | steps. Adjustments in one category |
| | | parameter influences others through | (e.g., Tone) propagate to others (e.g., |
| | | entanglement-like dependencies. | Style or Output). This maintains |
| | | | continuity and reduces cognitive load |
| | | | for the user while preserving overall |
| | | | project integrity. |
| 53 | Quantum | A quantum-inspired recurrent dynamic system | PROMPTS applies QRC to maintain |
| | Reservoir | used to store and evolve complex state | adaptive memory over the course of a |
| | Computing | histories. It can represent higher-order | single session. It helps the model |
| | (QRC) | memory patterns without explicit long-term | track evolving user intent, style |
| | | storage. | preferences, and correction trends. |
| | | | QRC enables PROMPTS to produce |
| | | | results that reflect an integrated |
| | | | understanding of the entire |
| | | | conversation. |
| 54 | Quantum | A hybrid robust-control mechanism combining | In PROMPTS, Q-H∞ensures |
| | Error-Mitigated | H∞stability with quantum error-mitigation | robustness when user inputs contain |
| | H∞ Controller | principles. It withstands uncertainty while | conflicting, highly creative, or |
| | (Q-H∞) | preventing runaway drift in highly variable | structurally ambiguous guidance. It |
| | | environments. | stabilizes the adaptive loop and |
| | | | prevents cumulative errors in |
| | | | downstream steps. The result is a |
| | | | more reliable and predictable final |
| | | | prompt without oversuppression of |
| | | | creativity. |
| 55 | Two-Degree- | This controller separates proactive | In PROMPTS, the 2-DOF controller |
| | of-Freedom | (feedforward) and reactive (feedback) | manages forward projection of user |
| | Hybrid | responses into distinct channels, enhanced by | intent while also correcting |
| | Controller (2- | quantum-inspired evaluation. It allows | misalignment in real time. This dual- |
| | DOF Quantum- | simultaneous planning and correction. | loop structure helps PROMPTS remain |
| | Classical) | | both foresighted and responsive. It |
| | | | ensures outputs reflect both the |
| | | | immediate choice and the broader |
| | | | project trajectory. |
| 56 | Quantum | A coherence-maintaining mechanism that | PROMPTS uses QCS to keep long |
| | Coherence | prevents conceptual drift by stabilizing phase | prompts, multi-step instructions, and |
| | Stabilizer (QCS) | relationships between generated ideas. It | complex creative outputs internally |
| | | maintains a stable narrative trajectory even | consistent. It prevents meaning drift |
| | | under high entropy. | during inventive stages and helps |
| | | | maintain definitional clarity. This |
| | | | enables PROMPTS to provide bold but |
| | | | structurally coherent suggestions |
| | | | throughout the adaptive loop. |

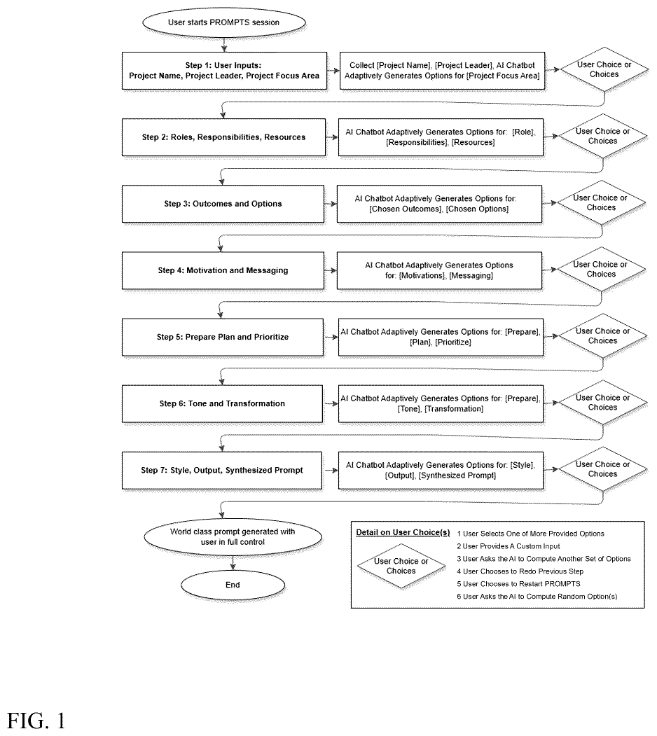

FIG. 1 presents the PROMPTS Adaptive Prompt Generation Framework as a step-by-step interactive flowchart that guides a user through the seven stages of the PROMPTS process. While PROMPTS is shown as the preferred embodiment, the adaptive framework described here can be applied to many other prompt-engineering systems, including RCSF, RTF, APE, TAG, ERA, BAB, CARE, and other structured approaches. The figure combines the process flow with the adaptive closed-loop control architecture so the examiner can see both the procedural sequence and the feedback logic that enables the framework to adjust itself in real time.

At the top of the figure, the user begins a PROMPTS session by entering initial information such as Project Name, Project Leader, and Project Focus. Each of the seven PROMPTS steps appears in a vertical sequence of labeled rectangular blocks. For each step, the AI chatbot generates a set of adaptive suggestions tailored to the user's previous selections. These suggestions are arranged as twelve options divided across four adaptive suggestion categories: narrowly aligned, moderately aligned, creatively divergent, and dynamically adjusted. Although twelve suggestions is the preferred embodiment, the number of suggestions can be increased or decreased as part of the adaptive framework.

To the right of each step block is a diamond labeled “User Choice or Choices.” This diamond represents the full set of actions a user may take at that stage. The figure supports six distinct user-choice modes where the user can select one or more of the provided suggestions:
1. Choose one or more of Options 1-12.
2. Enter a custom input, replacing the AI-generated suggestions with the user's own wording or idea.
3. Ask the AI to compute another set of 12 options for the user to review and choose from.
4. Redo the current step, causing the adaptive engine to regenerate a fresh set of suggestions with updated parameters.
5. Restart the entire PROMPTS framework, returning directly to Step 1 and clearing the adaptive state.
6. Ask the AI to produce a random option or options, allowing the adaptive framework to compute one or more options from the available suggestions using weighted pseudorandom logic. Although the AI produces these random options, the user remains in full control of selection or rejection.

All six actions are shown at the bottom right of the diagram as valid user decision paths. Selecting an option moves the user forward to the next PROMPTS step. Entering custom input inserts the user's text into the adaptive memory state. Asking the AI to choose triggers the meta-controller to generate an internally weighted selection. Redoing a step loops back to the same stage. Restarting returns to the top of the flowchart.

At the bottom of the figure, Step 7 concludes the PROMPTS sequence by synthesizing all user inputs into a final world-class prompt. A rounded box labeled “World-Class Prompt Generated with User in Full Control” highlights that the user remains the primary author throughout the entire process. The flowchart ends with an “End” block, though the user may also choose to begin a new PROMPTS session immediately.

FIG. 1 therefore communicates three essential concepts:
(1) PROMPTS is a structured, multi-step interactive framework.
(2) At every step, the user has complete authorship control and can choose among several decision paths.
(3) The underlying system adapts continuously through a closed-loop feedback architecture that adjusts suggestions and internal parameters in real time.

### Implementation Using OpenAI's CustomGPT Environment

The inventor recommends deploying the PROMPTS™ Adaptive Prompt Generation Framework within the OpenAI CustomGPT architecture to enable closed-loop adaptive interaction between user authors and the generative model. The CustomGPT environment provides a secure, logically-partitioned two-part operational structure consisting of (i) a private execution area, in which the proprietary control algorithms, parameter tuning logic, and meta-controller routines are hosted, and (ii) a public interactive area, in which the user communicates with the model to guide the creative and analytical processes.

Within the private area, the inventor's adaptive framework operates behind the CustomGPT firewall. This protected layer maintains the confidential meta-controller logic, the library of control mechanisms, and the variable distribution engine that governs the balance among the four primary suggestion categories (Narrowly Aligned, Moderately Aligned, Creatively Divergent, and Dynamically Adjusted). These algorithms are not exposed to the user, ensuring that proprietary adaptive tuning functions remain secure while still influencing the model's behavior in real time.

The public interactive area implements the user-author control loop where the system presents response options, collects user selections, and adjusts system parameters through the adaptive control mechanisms operating in the private layer. This design ensures that the human author remains the controlling agent of all consequential creative or analytical decisions. The user's actions serve as the external feedback signal that guides the meta-controller, while the underlying algorithms interpret, compute, and apply those changes within the protected private environment.

Implementable Control Mechanisms within the CustomGPT Environment

Within the OpenAI CustomGPT environment, a substantial portion of the control mechanisms defined by the PROMPTS™ Adaptive Prompt Generation Framework can be effectively emulated using prompt-based logic, parameter tuning, and structured memory. Each of these mechanisms is implemented as a functional analog through prompt logic and parameter modulation applied prior to token sampling, allowing CustomGPT to emulate feedback control behavior within its inference cycle.

In the Narrowly Aligned category, mechanisms such as feedforward, feedback, proportional, integral, and derivative control can be implemented through context anchoring, temperature scaling, and adaptive user correction loops. Logical constructs equivalent to deadband, rate limiting, and anti-windup regulation stabilize responses by filtering minor preference noise and preventing excessive creative oscillation. Collectively, these classical control elements maintain precision, coherence, and compliance with the user's stated intent, allowing the CustomGPT to perform as a self-tuning stability buffer during adaptive generation.

In the Moderately Aligned category, the CustomGPT can emulate gain scheduling, fuzzy logic control, and observer-based adaptation by varying temperature and top-p parameters in proportion to user engagement signals. These mechanisms allow smooth transitions between familiar and exploratory responses, achieving low-risk novelty through hybrid prompt logic rather than external computation. Proportional-integral-derivative (PID) blending can be simulated by adjusting creative range incrementally with user feedback, while cascaded reasoning structures mimic multi-layer controllers that balance semantic accuracy with conceptual variation. Together, these elements enable the model to sustain coherent thought expansion while preserving contextual integrity, effectively acting as a conceptual “spring damper” within the creative process.

For the Creatively Divergent category, the CustomGPT environment can replicate several dynamic mechanisms by chaining conditional reasoning steps that emulate predictive, fuzzy, and bang-bang controllers. The feedforward and model predictive pairing can be simulated through forward-thinking prompt segments that anticipate downstream narrative consequences before final generation. Similarly, Fuzzy-PID and anti-windup logic can be expressed through adaptive weighting within internal reasoning paths that blend imagination with bounded control. These combined techniques allow the model to produce high-entropy, lateral ideas while maintaining a controlled divergence rate aligned with user preference and task context.

In the Dynamically Adjusted category, the meta-controller within CustomGPT can approximate model predictive, Kalman filter, and fuzzy gain-scheduling behavior through weighted heuristic computation based on real-time user input. These adjustments continuously reshape category balance, adjusting the number of responses (cardinality) and entropy level in response to user openness, certainty, or fatigue. The model can maintain temporal stability through rate-limit logic and observer emulation, tracking engagement metrics such as time between selections or re-rolls. By combining these adaptive controls with the existing PROMPTS feedback framework, the CustomGPT can function as a closed-loop learning system that evolves toward optimal user satisfaction and authorship assurance within each session.

At this time, certain advanced control mechanisms-particularly those involving robust Ho regulation, sliding-mode control, and full-state optimal controllers such as LQR/LQG cannot yet be fully emulated within CustomGPT because they require continuous mathematical feedback and state-space computation. Likewise, true Kalman filtering, model predictive control with numerical optimization, and quantum control methods (such as quantum PID, tunneling, and annealing algorithms) remain beyond the current capability of embedded CustomGPT environments. These mechanisms depend on persistent variable storage, real-time matrix updates, or hybrid quantum-classical computation that the current system does not possess. As the current system progresses and as external connectivity and advanced plugin frameworks mature, these higher-order control elements can be integrated to further refine and extend the adaptive performance of the PROMPTS adaptive prompt generation framework.

Emulation of Meta-Controller Architecture within the CustomGPT Environment

The meta-controller architecture defined by the PROMPTS™ Adaptive Prompt Generation Framework can be fully conceptualized within the operational boundaries of an OpenAI CustomGPT instance. Although no physical processor or electronic circuitry is directly accessible, the CustomGPT environment provides logical and functional equivalents to a traditional microprocessor system, including compute, memory, input/output, and control pathways. These equivalents enable the PROMPTS meta-controller to execute instruction-like operations, maintain stateful variables, and regulate adaptive prompt behavior as if operating on a dedicated embedded controller.

The microprocessor function of the meta-controller is emulated through the generative model's internal reasoning layer and token-by-token computation engine. Each inference step acts as an instruction cycle, executing control logic defined within the hidden “private” layer of the CustomGPT. Decision trees embedded in the prompt logic emulate branching, conditional evaluation, and multi-threaded task scheduling. The CustomGPT's internal computation pipeline thus serves as a virtual control unit capable of performing multi-stage decision processing comparable to a firmware-based adaptive controller.

The memory subsystem of the meta-controller is simulated through the persistent and transient memory features available in CustomGPT. Short-term conversational context functions as volatile random-access memory (RAM), holding temporary variables such as current user intent, active mechanism states, and temperature or weighting factors. Longer-term memory functions, including style retention, tone calibration, and control-state recall, operate through stored instruction parameters and user-specific embeddings that approximate non-volatile memory (NVM). This dual-memory structure enables the meta-controller to “recall” and “update” state data between prompt cycles, supporting adaptive learning and continuity across the PROMPTS process.

The input/output (I/O) interface of the meta-controller is implemented through the CustomGPT's bidirectional conversational channel. User text input, file uploads, or selections serve as sensor data entering the I/O bus, while the model's textual outputs and generated options serve as actuator responses. This input-output loop is governed by the PROMPTS feedback layer, which processes user choices and routes them back into the internal control cycle as weighted feedback variables. As a result, each conversational turn within the CustomGPT instance functions as a closed I/O transaction between human and machine subsystems.

The system control bus and interconnect logic are represented virtually through the meta-controller's instruction framework, which coordinates access to the mechanism scheduler, option generator, and feedback loop modules. Logical “interrupts” are emulated by user-triggered events such as re-rolls, corrections, or command keywords that shift the controller's operational mode. These internal linkages create a unified computational fabric through which the PROMPTS meta-controller performs real-time adaptive regulation within a secure CustomGPT environment.

This configuration represents a software-based emulation of a hardware-inspired control architecture, enabling the PROMPTS meta-controller to perform microprocessor-equivalent regulation entirely within an AI-hosted runtime. The resulting system exhibits the operational characteristics of an embedded adaptive controller-computation, state memory, input-output control, and closed-loop feedback-without requiring any external hardware or firmware implementation. This embodiment demonstrates that an OpenAI CustomGPT instance can function as a virtual adaptive processor for generative systems, achieving meta-control through prompt-engineered logic and managed memory states.

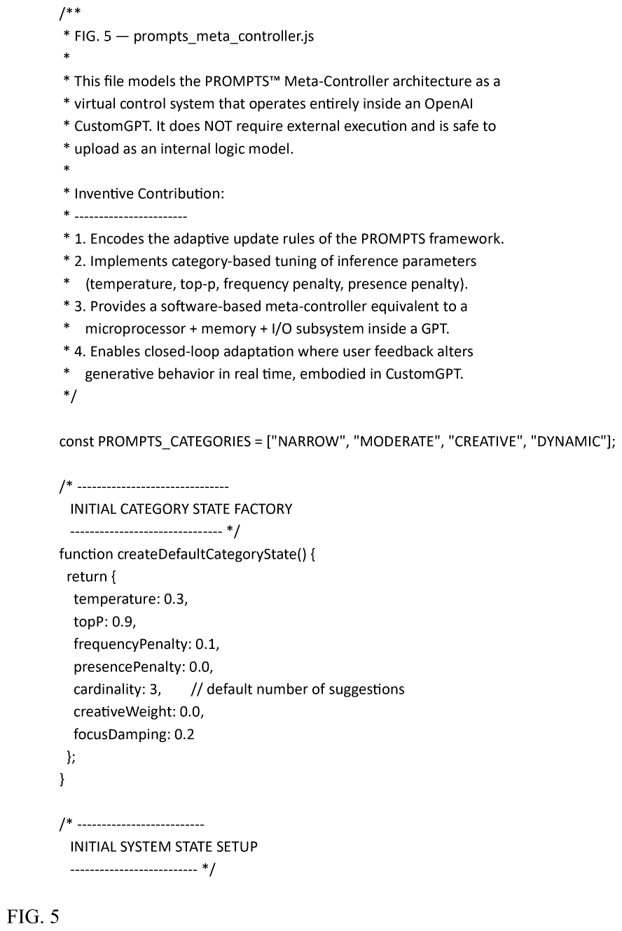

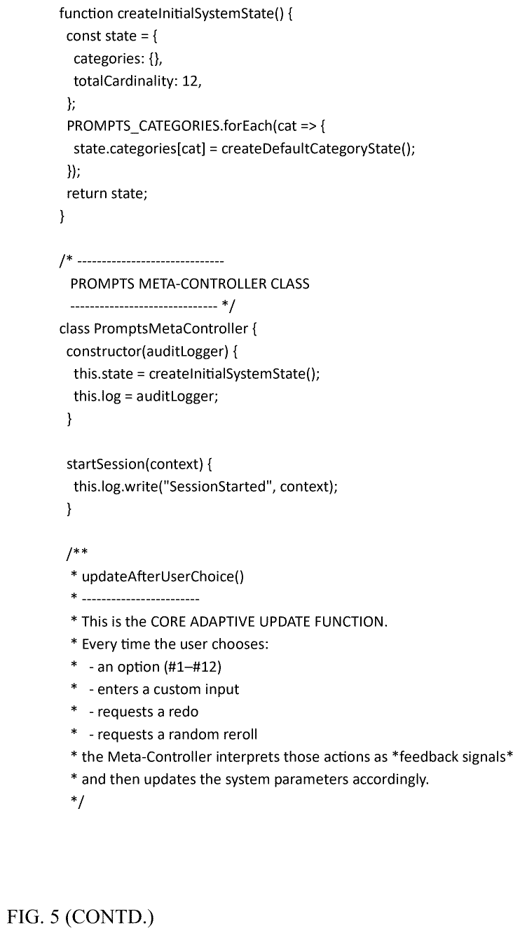

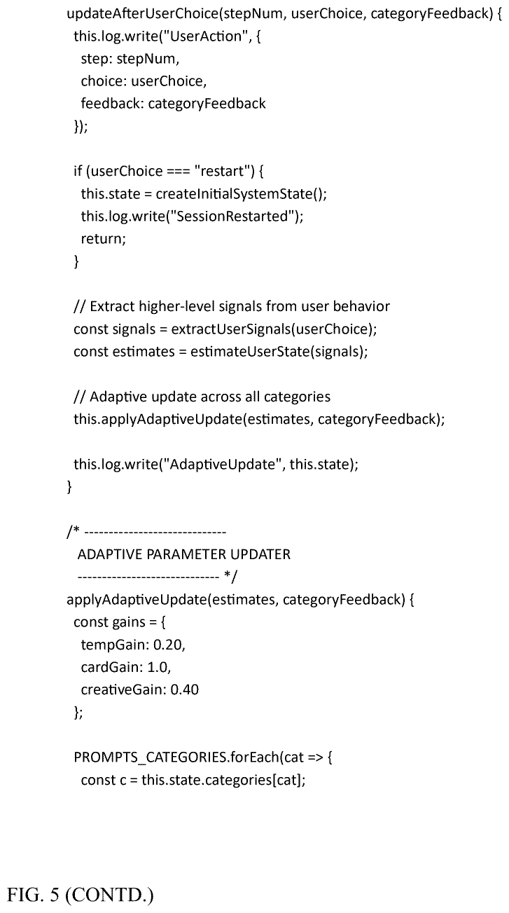

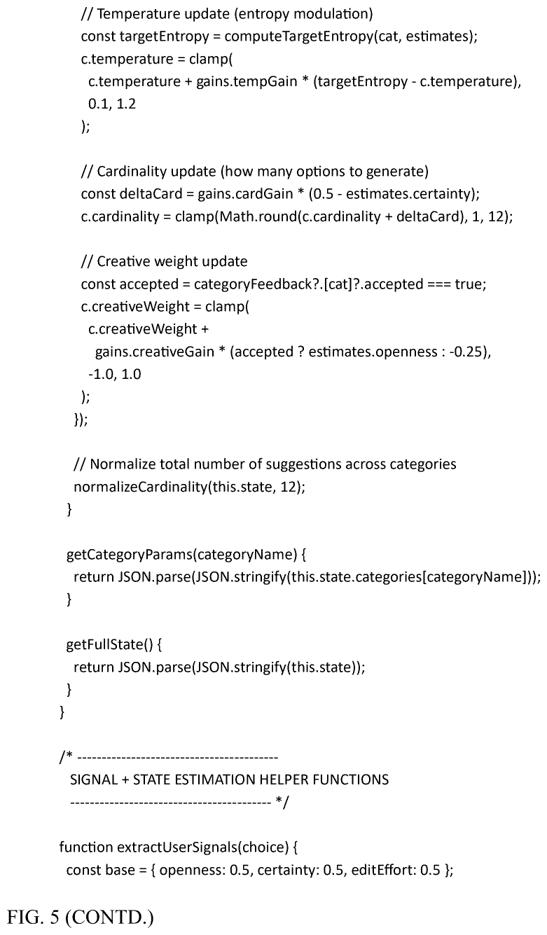

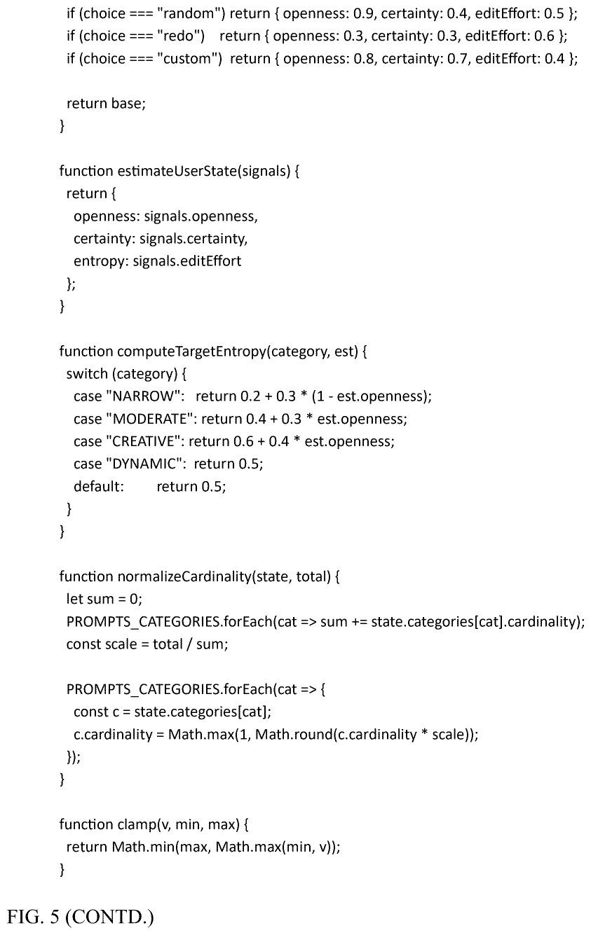

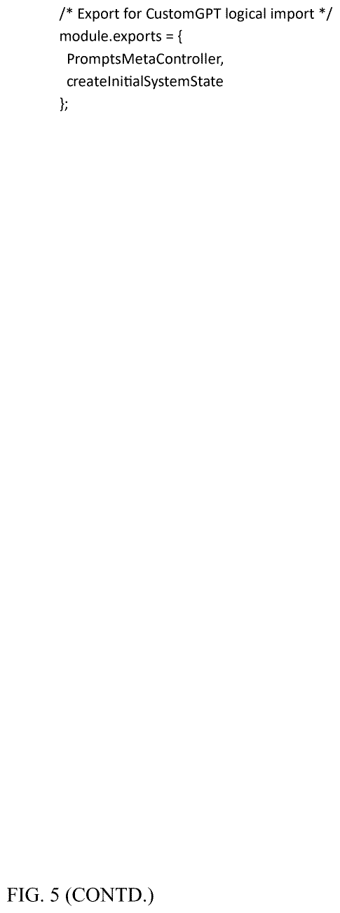

FIG. 5 provides Meta-Controller Logic+Adaptive Update Mechanisms With Documentation.

### Description of Closed Loop Adaptive Control System: AI Chatbot (CustomGPT), Adaptive Prompt Generation Framework, Meta-Controller, and User

### 1. System Overview

At runtime, the AI Chatbot (e.g., a CustomGPT) acts as the execution environment for the Adaptive Prompt Generation Framework. Within that environment:
The PROMPTS Framework defines the logical flow (steps 1-7, user interactions, and adaptive loops).
The Meta-Controller Subsystem manages how the AI Chatbot adjusts its internal “thinking parameters” (temperature, top-p, Frequency Penalty, Presence Penalty, Response Count (nm), Creativity Weight (W) across each of the four suggestion categories.
The Control Mechanisms implement low-level mathematical logic to keep the system stable and context-aware.

While the AI Chatbot never directly modifies its base model weights, it can dynamically tune inference-time parameters and synthetic control variables that shape its generative behavior.

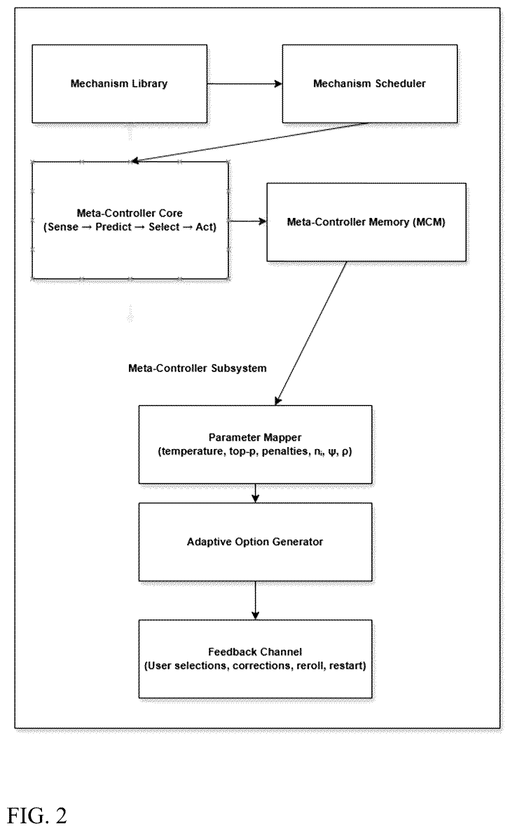

FIG. 2 shows the internal architecture of the Meta-Controller Subsystem that powers the PROMPTS Adaptive Prompt Generation Framework. This subsystem operates inside the CustomGPT environment (or an equivalent AI execution engine) and is responsible for interpreting user actions, selecting appropriate control mechanisms, tuning model parameters, and updating the system's adaptive state before each PROMPTS step.

At the center of FIG. 2 is the Meta-Controller Core, a rectangular block that performs the four fundamental control-cycle phases: Sense→Predict→Select→Act. The Core receives user-choice signals from the PROMPTS flow (shown in FIG. 1), evaluates the system's current vector state, and updates parameter values and category distributions accordingly. These internal adjustments determine the range and style of the next set of suggestions that will be presented to the user.

Connected to the Meta-Controller Core is the Mechanism Scheduler, which ranks the available control mechanisms-such as PID, Fuzzy Logic, Model Predictive Control (MPC), Observer models, and adaptive gain tuning-according to the system's current needs. The Scheduler selects one or more mechanisms to operate during the next generation cycle. The specific mechanisms chosen depend on the user's interaction pattern, the desired alignment of the next suggestions, and the internal stability constraints defined by the adaptive framework.

Below the core, the Meta-Controller Memory (MCM) maintains structured records of system state, including:
the control vector (temperature, top-p, penalties, entropy weight ψ, focus damping p, cardinality nᵢ)
mechanism weights
user-selection history
stored constraints for each suggestion category

This memory allows the system to behave as a stateful controller rather than a stateless text generator, enabling the adaptive and cumulative character of the PROMPTS framework.

On the left side of the architecture is the Mechanism Library, containing the catalog of control mechanisms the Scheduler may choose from. Only a subset is currently implementable inside CustomGPT, while the remainder represent future embodiments. FIG. 2 distinguishes this library block from the Scheduler to clarify that selection and storage are two separate functions.

To the right of the Meta-Controller Core is the Parameter Mapper, which translates the selected mechanism outputs into actual model-generation parameters (temperature, top-p, penalties, suggested response count, alignment weighting, etc.). These values are then sent to the LLM's generation API during the next suggestion phase.

Below the Parameter Mapper is the Adaptive Option Generator, which uses the mapped parameters to create the next set of suggestion outputs across the four adaptive categories: narrowly aligned, moderately aligned, creatively divergent, and dynamically adjusted. This generator is responsible solely for producing candidate text options, not for evaluating or scoring them.

Finally, at the bottom is the Feedback Channel, which receives user selections, corrections, re-roll requests, custom inputs, and restart commands. The Feedback Channel converts these user actions into structured feedback signals that are fed back into the Meta-Controller Core and Memory. The architecture therefore functions as a fully closed-loop adaptive system, with each user action informing the next computational cycle.

FIG. 2 demonstrates that the Meta-Controller operates as the computational engine inside PROMPTS, regulating parameter updates, managing control mechanisms, and enabling adaptive suggestion generation. This subsystem is general enough to support not only PROMPTS but also other frameworks such as RCSF, RTF, APE, CARE, TAG, ERA, BAB, and future prompting systems that require adaptive user-in-the-loop control.

2. How the AI Chatbot Interfaces with PROMPTS

When a PROMPTS session starts:
1. The Chatbot receives a context vector built from the user's selections (e.g., Chosen Role, Chosen Focus Area, etc.).
2. This vector is passed into the Meta-Controller as the initial system state.
3. The Meta-Controller consults the Control Mechanism Library to set starting parameters for the four suggestion categories.

During each step (e.g., generating 12 Focus Areas or 12 Actions):
1. The Chatbot queries the Meta-Controller for current parameter settings per category.
2. The Meta-Controller returns a small configuration vector: Category: Narrow, {temperature=0.15, top_p=0.85, freq_penalty=0.1, presence_penalty=0.0, creative_bias=−0.5}
   These parameters are passed into the model's generation API before token sampling, which is the actual process where the large language model decides which word or token to output next token.
3. The AI Chatbot or LLM then generates candidate text samples under those new parameter settings or constraints established by the adaptive prompts generation framework.
4. The Feedback Manager reviews the user's selections, rejections, “start-overs”, or custom inputs and feeds the selection back to the Meta-Controller for further tuning.

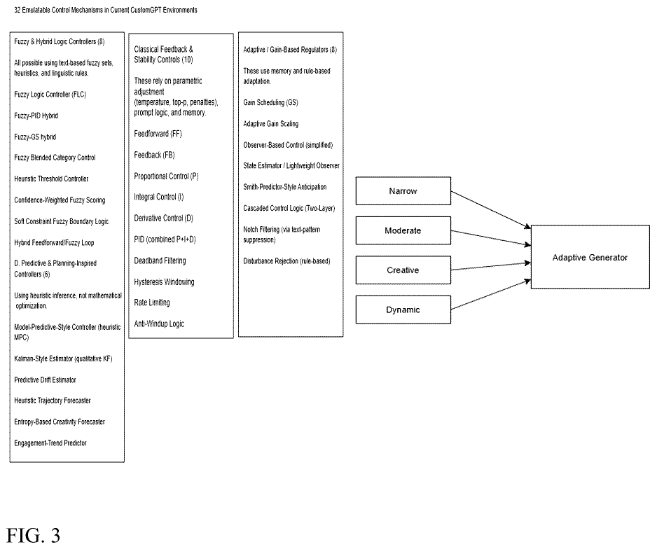

FIG. 3 illustrates the organization of the control mechanisms used by the PROMPTS™ Adaptive Prompt Generation Framework and shows how these mechanisms are grouped into four primary suggestion categories: Narrowly Aligned, Moderately Aligned, Creatively Divergent, and Dynamically Adjusted. FIG. 3 displays how the system uses different types of controllers to shape the variety, precision, and creativity of the suggestions displayed to the user at each stage of PROMPTS or any other compatible prompt framework.

FIG. 3 presents four vertically aligned rectangular blocks, each labeled with one of the four suggestion categories. Inside each block, a compact list of representative control mechanisms is shown. These mechanisms come from the inventor's larger library of 56 mechanisms of which 32 are currently implementable with a CustomGPT. FIG. 3 shows the preferred embodiment, in which a subset of the mechanisms is implemented inside an OpenAI CustomGPT environment through inference-time parameter tuning, structured prompt logic, adaptive user-feedback processing, and lightweight state estimation.

The Narrowly Aligned block contains classical stabilizing controllers such as feedforward, feedback, proportional, integral, derivative, deadband, hysteresis, and rate-limiting. These maintain high accuracy, reduce drift, and minimize unnecessary creativity. The Moderately Aligned block contains controllers that introduce mild novelty through gain scheduling, fuzzy logic blending, observer-based adjustment, and hybrid PID structures. The Creatively Divergent block contains exploratory controllers that enable bold conceptual shifts, such as fuzzy-PID, bang-bang logic, feedforward plus model predictive control, and novelty-injection mechanisms. The Dynamically Adjusted block contains controllers that regulate the adaptive behavior of the entire system, including simplified model predictive control, Kalman-style filtering, fuzzy gain scheduling, dual-loop architectures, and dynamic reweighting logic.

Arrows from each block point to a central region representing the Adaptive Suggestion Generator. These arrows indicate that each category contributes its own set of controller effects depending on the user's behavior and the real-time evaluations performed by the Meta-Controller. FIG. 3 also includes a brief note that the number of response options per category (cardinality) and the boundaries between categories are adjustable and not fixed. PROMPTS uses four categories in the preferred embodiment, but the adaptive framework can support more or fewer categories depending on the design of future prompt frameworks.

TABLE 13
Key Parameters Adjusted per Category

| | | Typical | |
|---|---|---|---|
| Parameter | Description | Range | Function |
| Temperature (τ) | Controls randomness in | 0.1-1.2 | Lower for Narrow, higher for Creative. |
| | token sampling. | | |
| Top-p (nucleus | Limits token pool by | 0.7-1.0 | Tighter for precision, looser for exploration. |
| sampling) | cumulative probability. | | |
| Frequency | Reduces repetition of | 0.0-1.0 | Higher in Creative to increase diversity. |
| Penalty | frequent words. | | |
| | Encourages introducing | | |
| Presence Penalty | new concepts. | 0.0-1.0 | Higher in Creative/Dynamic. |
| Response Count | Number of suggestions | 1-12+ | Adjusted dynamically by the Variable |
| (nᵢ) | per category. | | Distribution Engine. |
| Creativity | Internal heuristic variable | | Maps user openness to entropy modulation. |
| | used by the Meta- | −1.0-+1.0 | |
| Weight (ψ) | Controller. | | This is emulated within prompt logic. |
| Focus Damping | Internal smoothing term | 0.0-1.0 | Prevents oscillations when user input shifts |
| (ρ) | controlling context | | tone quickly. This is implemented within |
| | sensitivity. | | prompt logic |

### How the Meta-Controller Computes Changes

The Meta-Controller operates as a hybrid feedforward+feedback control loop. It can be thought of as a self-tuning regulator that continuously estimates user engagement, semantic coherence, and entropy divergence across prompt generations.

### Stepwise Logic

1. Signal Extraction: System collects recent user interactions (time between clicks, re-roll counts, degree of manual editing).
2. State Estimation: A simplified Kalman Filter or Observer Model estimates latent variables:
   User Openness (O)
   User Certainty (C)
   Semantic Drift (D)
   Entropy Score (E)
3. Category Rebalancing: Using these signals, the Meta-Controller updates each category's cardinality n₁ and temperature vector τᵢ by applying weighted rules:
   τᵢ(new)=τᵢ(old)+k₁*(E_target−E_current)+k₂*(ΔO)
   nᵢ(new)=nᵢ(old)+k₃*(C baseline−C_current)
   Where k₁ . . . k₃ are adaptive gains set by the control mechanism (PID, Fuzzy Logic, MPC, etc.).
4. Constraint Enforcement: The Meta-Controller ensures:
   Σnᵢ=N_total
   τᵢ∈[0.1, 1.2]
   0≤top_pᵢ≤1.0
5. Update Broadcast: Updated parameters are passed to the Chatbot's next generation call, closing the loop.

TABLE 14
Example Adaptive Behavior

| Situation | Meta-Controller Response | Effect on Outputs |
|---|---|---|
| User accepts first option | Decrease temperature for all categories | System stabilizes, fewer |
| repeatedly | | surprising options |
| User repeatedly | Increase creative weights ψ, raise τ for | Produces more novel or |
| types “random” | creative & dynamic categories | divergent ideas |
| User edits phrasing but | Slightly raise top-p, lower frequency | Enhances clarity without |
| not meaning | penalty | losing coherence |
| User skips steps or | Increase damping ρ, shorten response list | Reduces cognitive overload |
| abandons session | | for next step |
| User types in their own | Increase contextual weighting of user- | Updates internal certainty |
| custom input | defined tokens | baseline accordingly |

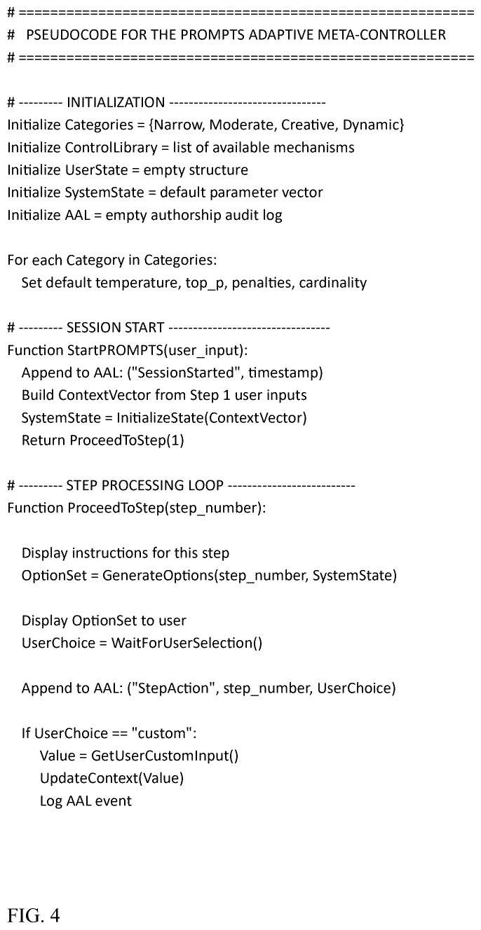

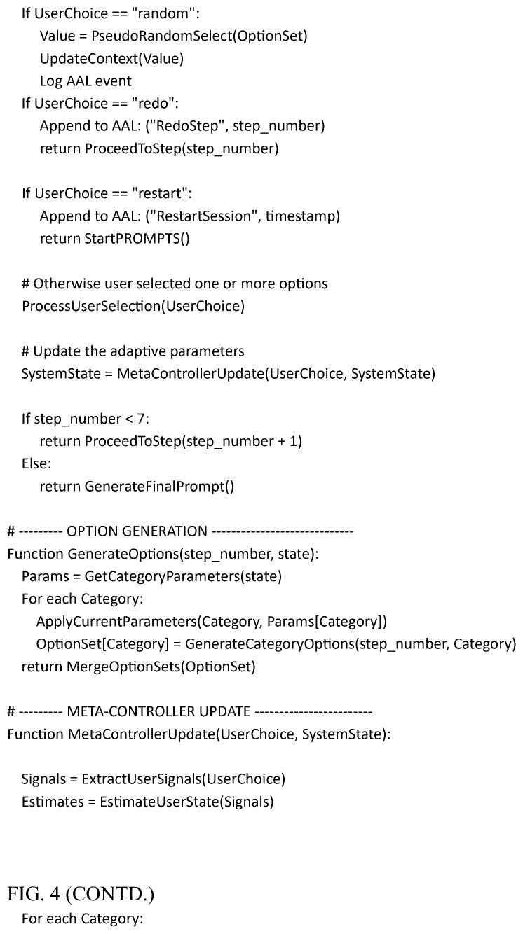

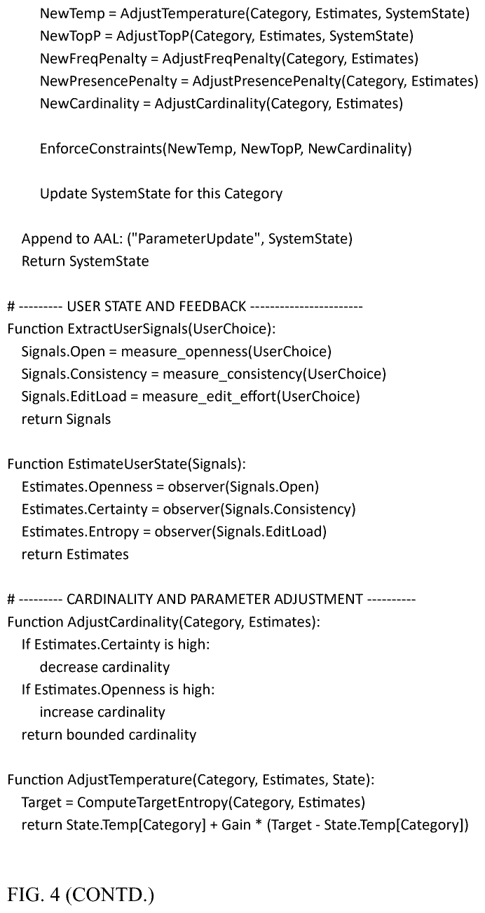

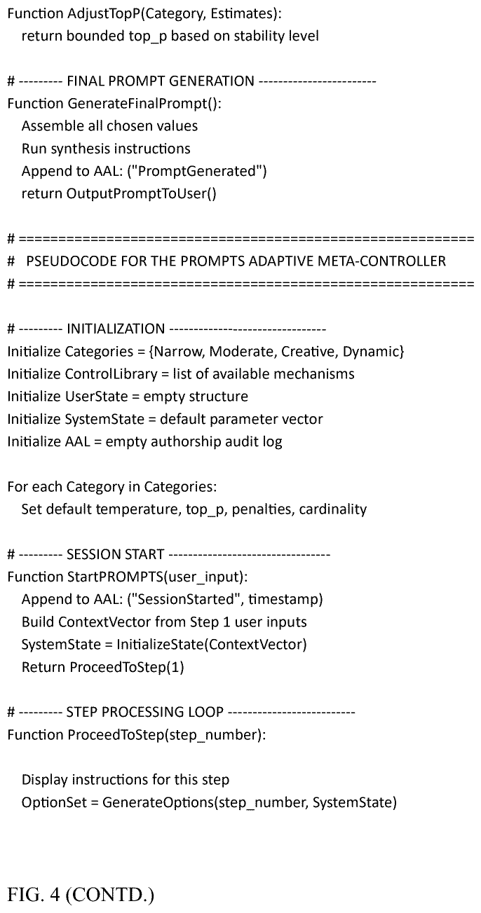

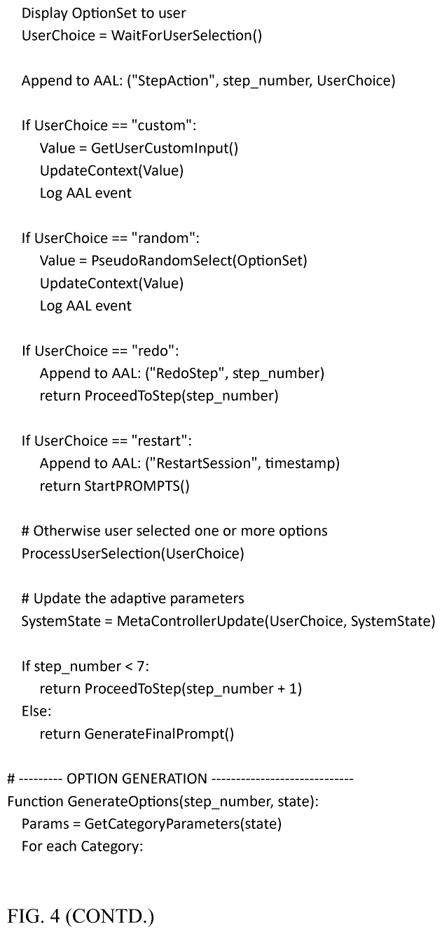

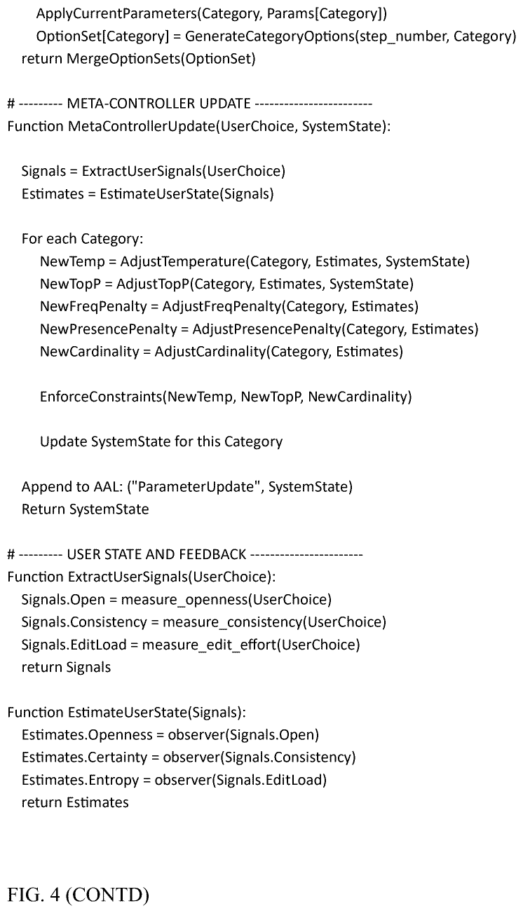

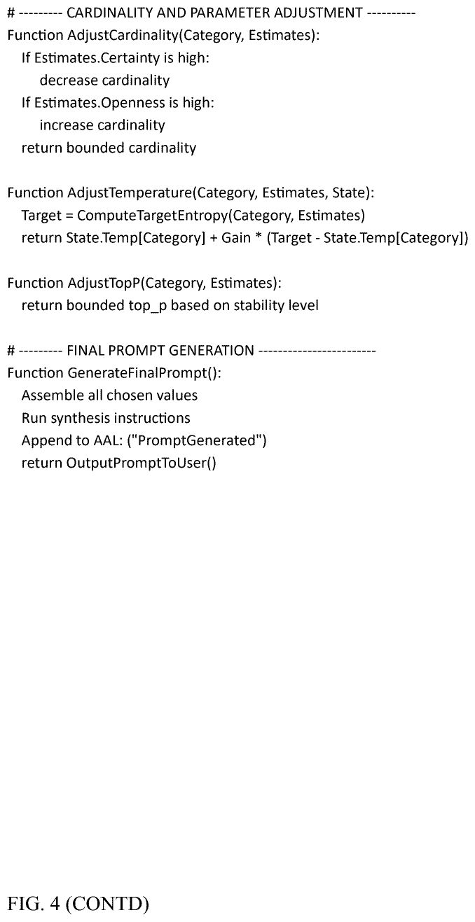

FIG. 4 illustrates the PROMPTS Adaptive Meta-Controller Pseudocode.

FIG. 5 illustrates PROMPTS Meta-Controller Logic+Adaptive Update Mechanisms With Documentation.

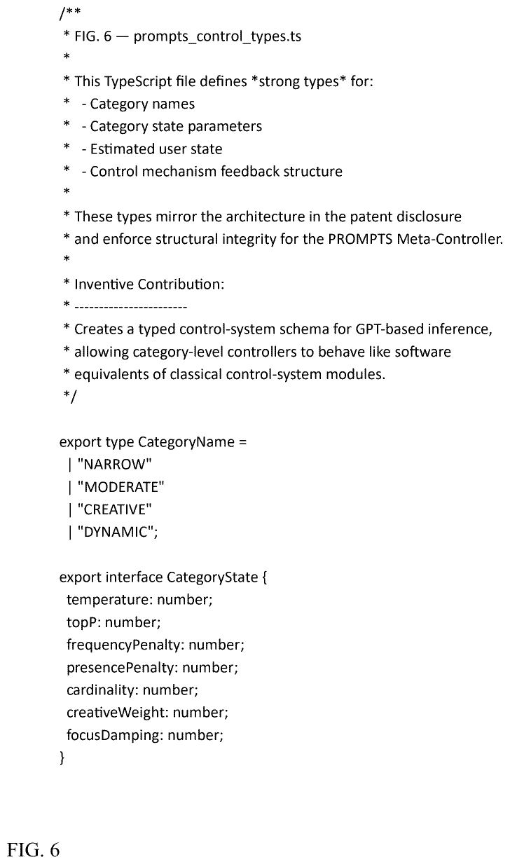

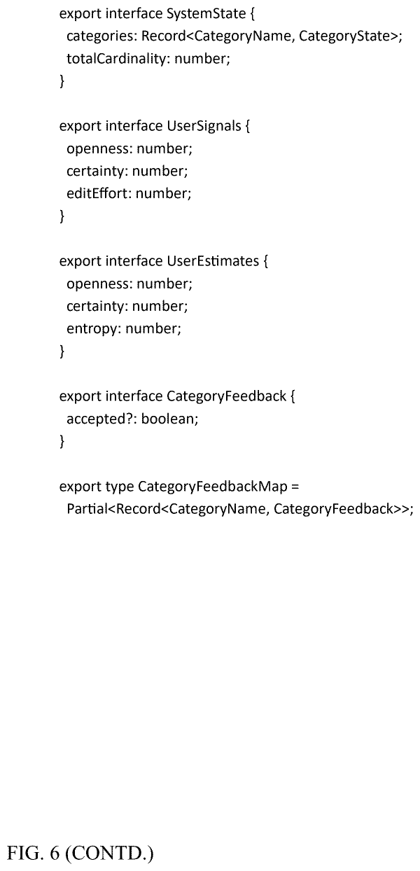

FIG. 6 shows PROMPTS Strong Types+Category Definitions+Controller Interfaces With Documentation

### Future Extensions that are Beyond the Capabilities of Today's CustomGPTs

The following enhancements are architected and taught in this patent, but not yet directly programmable inside CustomGPTs today:
External persistent vector memory: Long-term storage of user adaptation profiles across sessions.
Multi-controller coordination: Independent PID and fuzzy loops operating concurrently for each suggestion category.
Cross-model orchestration: Routing user input dynamically between models (e.g., GPT-4, Claude, Gemini) for ensemble optimization.
Quantum-inspired parameter modulation: Highly parallel superposition of competing prompt distributions for exploratory generation.

These functions remain architecturally defined and are intended for future implementation as OpenAI or equivalent platforms enable external plugin connectivity, real-time vector persistence, or hybrid model orchestration.

### SUMMARY

The AI Chatbot serves as the execution shell. The PROMPTS Adaptive Framework defines the conversational and logical structure. The Meta-Controller is the computational brain regulating real-time parameter tuning. The User is the human-in-the-loop overall controller of the process. Together, these elements form a closed-loop adaptive generation system that continuously regulates creative entropy and contextual coherence through measurable user feedback, maintaining human authorship while adaptively optimizing model behavior.

This hybrid deployment method enables the inventor to achieve full user authorship control and adaptive prompt evolution while maintaining the confidentiality of the underlying algorithms. The separation of user-facing logic and proprietary adaptive systems represents a preferred embodiment that leverages the existing OpenAI CustomGPT platform while preserving intellectual property integrity and data privacy. The inventive aspect of this lies in combining user-in-the-loop adaptive feedback with real-time inference parameter modulation, governed by a virtual meta-controller that operates entirely within a CustomGPT instance.

### General Disclosure of Emerging Extensions

The disclosed PROMPTS architecture is expressly designed to accommodate continuous technical evolution across control, computation, and interaction modalities. The framework's modular control design supports hybrid state-space optimization, in which linear and nonlinear submodels operate concurrently, and Lyapunov-based stability proofs can be applied to verify convergence of adaptive learning dynamics. Controller parameters may be enhanced through reinforcement-learning auto-tuning, allowing the system to self-optimize using reward signals derived from user feedback and Authorship Assurance Log (AAL) data. To maintain usability, cognitive-load modeling is incorporated to measure the user's decision bandwidth and automatically scale the number and diversity of presented options. The architecture further anticipates an Ethical Constraint Controller (ECC) layer that formalizes moral and regulatory invariants as sliding-mode constraints, guaranteeing that no adaptive path violates ethical boundaries. At the computational level, PROMPTS is deployable through distributed GPU and edge-processing nodes for real-time multi-agent orchestration. All interaction states are recorded in standardized metadata formats enabling provenance interoperability across platforms, while its multi-modal interface schema supports seamless extension to image, audio, and haptic feedback channels, preserving the same closed-loop authorship control throughout.

FIG. 7 illustrates the PROMPTS Authorship Assurance Ledger (AAL) Implementation With Documentation.

FIG. 8 illustrates the complete system architecture for the PROMPTS™ Adaptive Prompt Generation Framework, including both the user-facing layers and the internal adaptive control layers that regulate how response options are generated, evaluated, and refined. The diagram shows how the system integrates user input, adaptive control logic, category-balanced option generation, and secure data handling into a single closed-loop structure. The layout also highlights the separation between public user interaction and the protected CustomGPT execution environment where proprietary algorithms operate.

At the top of the diagram, the User Interaction Layer receives the user's selections, custom inputs, corrections, rerolls, or requests to restart. These inputs drive the PROMPTS workflow that proceeds through Steps 1 through 7. Immediately below this, the PROMPTS Framework block represents the structured sequence of operations that transforms the user's choices into a consolidated context vector. This context vector serves as the main input to the adaptive control system.

The next block is the Meta-Controller Subsystem, which computes the adaptive parameters that shape generative behavior. The meta-controller examines the user's recent interactions, estimates variables such as openness, certainty, and semantic drift, and then selects which control mechanisms to activate. It also determines the parameter settings for each suggestion category, including temperature, top-p, penalties, and cardinality. This subsystem acts as the computational center of the framework.

The lower half of the diagram, shown in FIG. 8, depicts the internal components that apply the meta-controller's decisions. The Control Mechanism Library contains the set of classical and heuristic control mechanisms that can be emulated within the CustomGPT environment today. The Variable Distribution Engine adjusts the number of suggestions generated in each category and updates the balance among Narrowly Aligned, Moderately Aligned, Creatively Divergent, and Dynamically Adjusted outputs. Arrows from both components flow into the Generation Module, which applies the adaptive parameters during the model's inference process to produce user-visible options.

Below the generator, the Authorship Audit Log records user decisions, system parameters, and adaptation states. This log provides proof of authorship and supports later verification if a user's originality is ever challenged. The outer rectangle labeled CustomGPT Execution Shell encloses the internal blocks and represents the secure runtime environment. The private area hosts the meta-controller, Variable Distribution Engine, and Control Mechanism Library, while the public area includes the PROMPTS steps and user-facing dialogue.

Together, these blocks form a closed-loop adaptive system. User actions modify the system state, the meta-controller computes new parameters, and the generator produces refined outputs. The system can adjust in real time to align creative exploration, user control, and stable authorship assurance.

This master architectural diagram shows how PROMPTS™ integrates structured user dialog with a protected adaptive control layer inside the CustomGPT environment.

Specific Application within the PROMPTS Framework

Within PROMPTS™, these capabilities manifest as deeper layers of adaptability and verifiability. Hybrid state-space modeling enables the system to represent the user-AI interaction as a composite of fast linguistic dynamics and slower behavioral adaptation, while Lyapunov functions provide a provable measure that each iteration reduces stylistic error energy. Reinforcement-learning auto-tuning operates as a meta-controller that continually calibrates the forty-four underlying mechanisms to the unique reward structure of each user, effectively customizing the “personality” of the assistant. Cognitive-load analytics monitor how rapidly the user can evaluate suggestions; when overload is detected, the adaptive-distribution engine automatically narrows the option set or simplifies wording. The Ethical Constraint Controller functions as a non-negotiable guardrail, ensuring transparency, truthfulness, and brand-safe expression. Distributed GPU/Edge deployment allows multi-agent PROMPTS instances to collaborate on large documents with sub-second latency. Provenance interoperability ensures that every creative contribution remains cryptographically traceable to its human author across ecosystems. Finally, multimodal integration extends PROMPTS principles beyond text: image, sound, and haptic modalities obey identical feedback-control laws, maintaining human-in-command authorship across all generative dimensions.

The current invention provides real-time adaptability by continuously evolving through user feedback, enabling more engaging and personalized interactions than static systems. This framework's ability to dynamically adjust PROMPTS and integrate both feedforward and feedback controls sets it apart from traditional AI interaction models.

All publications, patents, and patent documents cited herein are incorporated by reference as though individually incorporated by reference. No limitations inconsistent with this disclosure are to be understood therefrom. The invention has been described with reference to various specific and preferred embodiments and techniques. However, many variations and modifications may be made while remaining within the spirit and scope of the invention.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

What is claimed is:

1. A framework for enhancing user-Artificial Intelligence (AI) interaction, comprising:
a. processing user input to extract context and preferences, comprising:
i. analysis of previous inputs; and
ii. contextual understanding
b. creating diverse response options comprising
i. closely related choices;
ii. moderately related choices
iii. creatively divergent choices
iv. unexpected but relevant alternatives;
c. user interactions interface comprising:
i. multiple choice selections;
ii. custom input capabilities;
iii. request additional options to select from
iv. repeat last step;
v. start over selection; and;
vi. AI generated random selection
d. adaptive learning mechanisms wherein the adaptive learning mechanism enables continuous refinement of option generation based on user selection and feedback comprising
i. processing and integration of user choices; and
ii. continuous refinement of option generation
e. adaptive control elements comprising
i. feedforward adaptive control; and
ii. feedback adaptive control.

2. The framework of claim 1, wherein the analysis of previous inputs comprises:
i. pattern recognition wherein pattern recognition recognizes one or more of frequently used phrases, and topics of interest the framework generates more relevant prompts; and
ii. preference identification, wherein identifying user preferences identifies preferred tone and/or style and allows the framework to customize responses to match individual preferences.

3. The framework of claim 1, wherein the contextual understanding comprises:
i. context analysis wherein the framework analyses the context of user inputs comprising one or more of current conversation topics, and user intent and emotional tone to generate contextually appropriate responses;
ii. dynamic context adaptation wherein the framework adapts to changes in context over the course of a conversation ensuring that responses remain relevant and engaging.

4. The framework of claim 1, wherein the closely related choices comprise:
i. contextually relevant options wherein the options generated closely relate to the current topic or user input, maintaining the flow of conversation and user engagement; and
ii. preference-aligned responses wherein options are tailored to align with user preferences providing a personalized interaction experience.

5. The framework of claim 1, wherein the AI generated random selection comprises:
i. creative divergence wherein random selection introduces creative divergence to provide users with new ideas and perspectives;
ii. preventing repetition, wherein random options are generated allowing the framework to avoid repetition and keep interaction dynamic and new.

6. The framework of claim 1, wherein unexpected but relevant alternatives comprises:
i. unexpected options wherein novelty of options is created in the interaction; and
ii. relevant innovations, wherein unexpected options remain relevant to the context contributing to the conversation.

7. The framework of claim 1, wherein the multiple-choice selection provides:
i. a guide for the conversation based on preferences; and
ii. choice variety for choosing a selection, wherein the variety ensures that users select the option that best aligns with their interest and needs.

8. The framework of claim 1, wherein the custom input capabilities comprise:
i. personalized interaction allowing users to input their responses enabling a more personalized and engaging interaction; and
ii. custom input flexibility accommodating a range of user needs and preferences.

9. The framework of claim 1, wherein the request for additional options comprises:
i. iterative exploration requesting additional options providing different ideas and perspectives; and
ii. enhanced engagement providing the ability to request more options keeping users engaged and invested in the conversation.

10. The framework of claim 1, wherein the processing and integration of user choices comprises:
i. learning from feedback wherein by processing user feed and choices continuously improves the framework understanding of user preferences; and
ii. adaptive refinement, wherein the framework adapts its behavior based on user feedback ensures that the future interactions align with user expectations.

11. The framework of claim 1, wherein the continuous refinement of option generation comprises:
i. dynamic learning, wherein the framework employs dynamic learning algorithms to continuously update its knowledge base and improve option generation; and
ii. adaptive evolution, wherein the framework evolves over time and adapts to changes in user preferences and behavior to provide a personalized experience.

12. The framework of claim 1, wherein the feedforward adaptive control proactively anticipates user preferences and generates options accordingly further comprising:
i. anticipating user preferences based on previous inputs, wherein by leveraging historical interaction data, the framework proactively generates options that align with anticipated user needs; and
ii. proactive option generation, wherein the framework generates options that respond to current inputs and anticipate future user needs and contexts.

13. The framework of claim 12, wherein the anticipating user preferences further comprises:
i. data-driven anticipation, wherein the framework uses data-driven techniques to predict user preferences based on past behavior and interactions; and
ii. proactive personalization wherein anticipating user needs allows the farmwork to provide a more personalized experience.

14. The framework of claim 12, wherein the proactive option generation further comprises:
i. forward-looking options, wherein generating forward-looking options, the PROMPTS framework stays ahead of user needs and maintains engagement;
ii. context aware anticipation wherein the framework anticipates changes in context and adjusts its responses accordingly ensuring a seamless interaction experience.

15. The framework of claim 1, wherein the feedforward adaptive control comprises:
i. forward-looking options proactively anticipating user needs and maintaining engagement; and
ii. context-aware anticipation wherein the framework anticipates changes in context and adjusts its responses accordingly.

16. The framework of claim 1, wherein the feedback adaptive control comprises:
i. incorporating user selections and custom inputs wherein real-time analysis of user choices allows the framework to adjust its behavior and output dynamically; and
ii. real-time adjustment of the framework behavior wherein the framework continuously refines its responses based on user feedback providing a responsive and engaging interaction.

17. The framework of claim 16, wherein the incorporating user selections and custom inputs comprises:
i. real time adaptation, wherein the framework adjusts is responses in real-time based on user feedback, ensuring a responsive and adaptive interaction; and
ii. user driven refinement wherein user selections and custom inputs are incorporated into the framework's learning process refining future interactions.

18. The framework of claim 16, wherein the real-time adjustment of the framework continuously refines its responses based on user feedback providing responsive and engaging interaction and further comprising:
i. dynamic response adjustment wherein the framework dynamically adjusts its responses based on real-time feedback further providing user engagement; and
ii. continuous improvement, wherein the framework continuously refines its behavior providing interactions that remain relevant and personalized over time.
